(19) United States
(12) Patent Application Publication
(10) Pub. No.: US 2012/0012191 A1
(43) Pub. Date: Jan. 19, 2012

(54) LIQUID RECOVERY APPARATUS, EXPOSURE APPARATUS, LIQUID RECOVERING METHOD, DEVICE FABRICATING METHOD, PROGRAM, AND STORAGE MEDIUM

(75) Inventor: Tadashi HOSHINO, Ageo-shi (JP)

(73) Assignee: NIKON CORPORATION, Tokyo (JP)

(21) Appl. No.: 13/181,189

(22) Filed: Jul. 12, 2011

Related U.S. Application Data
(60) Provisional application No. 61/364,933, filed on Jul. 16, 2010.

(51) Int. Cl. B67D 7/72

(52) U.S. Cl. 137/154

(57) ABSTRACT

A liquid recovery apparatus is used in an immersion exposure apparatus and is connected to a liquid immersion member, which is disposed at least partly around an optical path of exposure light that passes through an optical member and a liquid between the optical member and an object. The liquid recovery apparatus comprises: a first passageway, which is connected to a discharge part of the liquid immersion member that separately discharges the liquid and a gas from a recovery passageway of the liquid immersion member wherethrough the liquid recovered via a recovery port of the liquid immersion member flows, into which the liquid discharged via a first discharge port of the discharge part flows; a second passageway, into which the gas discharged via a second discharge port of the discharge part flows; and a first detection apparatus, which is disposed in at least part of the second passageway and detects the amount of the gas discharged via the second discharge port.

### CROSS-REFERENCE TO RELATED APPLICATION

This application is a non-provisional application claiming priority to and the benefit of U.S. provisional application No. 61/364,933, filed Jul. 16, 2010. The entire contents of which are incorporated herein by reference.

### BACKGROUND

1. Field of the Invention

The present invention relates to a liquid recovery apparatus, an exposure apparatus, a liquid recovering method, a device fabricating method, a program, and a storage medium.

2. Description of Related Art

As disclosed in, for example, U.S. Patent Application Publication No. 2009/0046261, among exposure apparatuses used in photolithography, an immersion exposure apparatus is known which exposes a substrate with exposure light through a liquid in an immersion space.

### SUMMARY

In an immersion exposure apparatus, for example, if the liquid are not recovered in a desired state, the immersion space cannot be formed satisfactorily; as a result, exposure failures might occur and thereby defective devices might be produced.

An object of the aspect of the present invention is to provide a liquid recovery apparatus, an exposure apparatus, and a liquid recovering method that can recover the liquid in a desired state and can prevent exposure failures from occurring. Another object of the aspect of the present invention is to provide a device fabricating method, a program, and a storage medium that can prevent defective devices from being produced.

A first aspect of the present invention provides a liquid recovery apparatus that is used in an immersion exposure apparatus, is connected to a liquid immersion member, which is disposed at least partly around an optical path of exposure light that passes through an optical member and a liquid between the optical member and an object, and comprises: a first passageway, which is connected to a discharge part of the liquid immersion member that separately discharges the liquid and a gas from a recovery passageway of the liquid immersion member wherethrough the liquid recovered via a recovery port of the liquid immersion member flows, into which the liquid discharged via a first discharge port of the discharge part flows; a second passageway, into which the gas discharged via a second discharge port of the discharge part flows; and a first detection apparatus, which is disposed in at least part of the second passageway and detects the amount of the gas discharged via the second discharge port.

A second aspect of the present invention provides a liquid recovery apparatus that is used in an immersion exposure apparatus, is connected to a liquid immersion member, which is disposed at least partly around an optical path of exposure light that passes through an optical member and a liquid between the optical member and an object, and comprises: a first passageway, which is connected to a first discharge port of a discharge part of the liquid immersion member that discharges the liquid and a gas from a recovery passageway of the liquid immersion member wherethrough the liquid recovered via a recovery port of the liquid immersion member flows; a second passageway, which is connected to a second discharge port of the discharge part that hinders the inflow of the liquid more than the first discharge port does; and a first detection apparatus, which is disposed in at least part of the second passageway and detects the amount of the gas discharged via the second discharge port.

A third aspect of the present invention provides a liquid recovery apparatus that is used in an immersion exposure apparatus, is connected to a liquid immersion member, which is disposed at least partly around an optical path of exposure light that passes through an optical member and a liquid between the optical member and an object, and comprises: a first passageway, which is connected to a discharge part of the liquid immersion member that separately discharges the liquid and a gas from a recovery passageway of the liquid immersion member wherethrough the liquid recovered via a recovery port of the liquid immersion member flows, into which the liquid discharged via a first discharge port of the discharge part flows; a second passageway, into which the gas discharged via a second discharge port of the discharge part flows; and a pressure detection apparatus, at least part of which is disposed in the recovery passageway and detects the pressure in the recovery passageway.

A fourth aspect of the present invention provides a liquid recovery apparatus that is used in an immersion exposure apparatus, is connected to a liquid immersion member, which is disposed at least partly around an optical path of exposure light that passes through an optical member and a liquid between the optical member and an object, and comprises: a first passageway, which is connected to a first discharge port of a discharge part of the liquid immersion member that discharges the liquid and a gas from a recovery passageway of the liquid immersion member wherethrough the liquid recovered via a recovery port of the liquid immersion member flows; a second passageway, which is connected to a second discharge port of the discharge part that hinders the inflow of the liquid more than the first discharge port does; and a pressure detection apparatus, at least part of which is disposed in the recovery passageway and detects the pressure in the recovery passageway.

A fifth aspect of the present invention provides an exposure apparatus that exposes a substrate with exposure light that transits a liquid and comprises: an optical member, wherefrom the exposure light emerges; a liquid immersion member, which is disposed at least partly around an optical path of the exposure light that passes through the liquid between the optical member and an object; and a liquid recovery apparatus according to any one aspect of the first through fourth aspects.

A sixth aspect of the present invention provides a device fabricating method that comprises: exposing a substrate using an exposure apparatus according to the fifth aspect; and developing the exposed substrate.

A seventh aspect of the present invention provides a liquid recovering method that is used in an immersion exposure apparatus, recovers a liquid via a recovery port of a liquid immersion member disposed at least partly around an optical path of exposure light, and comprises: discharging the liquid from a recovery passageway of the liquid immersion member, wherethrough the liquid recovered via the recovery port flows, via a first discharge port, which faces the recovery passageway; discharging a gas from the recovery passageway via a second discharge port, which faces the recovery passageway and hinders the inflow of the liquid more than the first discharge port does; and detecting the amount of the gas discharged via the second discharge port.

An eighth aspect of the present invention provides a liquid recovering method that is used in an immersion exposure apparatus, recovers a liquid via a recovery port of a liquid immersion member disposed at least partly around an optical path of exposure light, and comprises: discharging the liquid from a recovery passageway of the liquid immersion member, wherethrough the liquid recovered via the recovery port flows, via a first discharge port, which faces the recovery passageway; discharging a gas from the recovery passageway via a second discharge port, which faces the recovery passageway and hinders the inflow of the liquid more than the first discharge port does; and detecting the pressure in the recovery passageway.

A ninth aspect of the present invention provides a liquid recovering method that is used in an immersion exposure apparatus, recovers a liquid from a space above an object, which opposes a recovery port of a liquid immersion member disposed at least partly around an optical path of exposure light, via the recovery port, and comprises: starting the discharge of a fluid, which includes the liquid, via a first discharge port, which faces a recovery passageway of the liquid immersion member into which the liquid flows via the recovery port; starting the discharge of the fluid, which includes a gas, via a second discharge port, which faces the recovery passageway; detecting the amount of the gas discharged via the second discharge port; and adjusting the amount of the gas discharged from the recovery passageway via the second discharge port based on the detected gas amount; wherein, the fluid discharged via the first discharge port has a higher percentage of the liquid than of the gas; and the fluid discharged via the second discharge port has a higher percentage of the gas than of the liquid.

A tenth aspect of the present invention provides a device fabricating method that comprises: recovering at least some of a liquid that fills an optical path of exposure light radiated to a substrate by using a liquid recovering method according to any one aspect of the seventh through ninth aspects; exposing the substrate with the exposure light through the liquid; and developing the exposed substrate.

An eleventh aspect of the present invention provides a program that causes a computer to control an exposure apparatus, which exposes a substrate with exposure light that transits a liquid, and comprises: forming an immersion space such that the optical path of the exposure light radiated to the substrate is filled with the liquid in a state wherein a liquid immersion member is disposed at least partly around an optical path of the exposure light; exposing the substrate with the exposure light, which transits the liquid in the immersion space; recovering at least some of the liquid from a space above the substrate via a recovery port of the liquid immersion member; discharging the liquid from a recovery passageway of the liquid immersion member, wherethrough the liquid recovered via the recovery port flows, via a first discharge port, which faces the recovery passageway; discharging a gas from the recovery passageway via a second discharge port, which faces the recovery passageway and hinders the inflow of the liquid more than the first discharge port does; and detecting the amount of the gas discharged via the second discharge port.

A twelfth aspect of the present invention provides a program that causes a computer to control an exposure apparatus, which exposes a substrate with exposure light that transits a liquid, and comprises: forming an immersion space such that the optical path of the exposure light radiated to the substrate is filled with the liquid in a state wherein a liquid immersion member is disposed at least partly around an optical path of the exposure light; exposing the substrate with the exposure light, which transits the liquid in the immersion space; recovering at least some of the liquid from a space above the substrate via a recovery port of the liquid immersion member; discharging the liquid from a recovery passageway of the liquid immersion member, wherethrough the liquid recovered via the recovery port flows, via a first discharge port, which faces the recovery passageway; discharging a gas from the recovery passageway via a second discharge port, which faces the recovery passageway and hinders the inflow of the liquid more than the first discharge port does; and detecting the pressure in the recovery passageway.

A thirteenth aspect of the present invention provides a program that causes a computer to control an exposure apparatus, which exposes a substrate with exposure light that transits a liquid, and comprises: forming an immersion space such that the optical path of the exposure light radiated to the substrate is filled with the liquid in the state wherein a liquid immersion member is disposed at least partly around an optical path of the exposure light; exposing the substrate with the exposure light, which transits the liquid in the immersion space; recovering at least some of the liquid from a space above the substrate via the recovery port of the liquid immersion member; starting the discharge of a fluid including the liquid via the first discharge port, which faces a recovery passageway of the liquid immersion member into which the liquid flows via the recovery port; starting the discharge of a fluid including a gas via a second discharge port, which faces the recovery passageway; detecting the amount of the gas discharged via the second discharge port; and adjusting the amount of the gas discharged from the recovery passageway via the second discharge port based on the detected gas amount; wherein, the fluid discharged via the first discharge port has a higher percentage of the liquid than of the gas; and the fluid discharged via the second discharge port has a higher percentage of the gas than of the liquid.

A fourteenth aspect of the present invention provides a computer readable storage medium whereon a program according to any one aspect of the eleventh through thirteenth aspects is stored.

According to the aspects of the present invention, the liquid can be recovered in a desired state and exposure failures can be prevented.

In addition, the present invention makes it possible to prevent defective devices from being produced.

### BRIEF DESCRIPTION OF THE DRAWINGS

FIG. 1 is a schematic block diagram that shows one example of an exposure apparatus according to a first embodiment.

FIG. 2 is a side cross sectional view that shows one example of a liquid immersion member according to the first embodiment.

FIG. 3 is a partial side cross sectional view of the liquid immersion member according to the first embodiment.

FIG. 4 is a diagram that shows one example of a liquid recovery apparatus according to the first embodiment.

FIG. 5 is a schematic drawing that shows one example of a state wherein a second member according to the first embodiment recovers a liquid.

FIG. 6 is a flow chart that shows one example of the operation of the exposure apparatus according to the first embodiment.

FIG. 7 is a schematic drawing for explaining one example of the operation of the exposure apparatus according to the first embodiment.

FIG. 8 is a schematic drawing for explaining one example of the operation of the exposure apparatus according to the first embodiment.

FIG. 9 is a partial side cross sectional view of the liquid immersion member according to a second embodiment.

FIG. 10 is a partial side cross sectional view of the liquid immersion member according to the second embodiment.

FIG. 11 is a partial side cross sectional view of the liquid immersion member according to the second embodiment.

FIG. 12 is a partial side cross sectional view of the liquid immersion member according to the second embodiment.

FIG. 13 is a flow chart for explaining one example of a microdevice fabricating process.

### DESCRIPTION OF EMBODIMENTS

The embodiments of the present invention will now be explained, referencing the drawings; however, the present invention is not limited thereto. The explanation below defines an XYZ orthogonal coordinate system, and the positional relationships among parts are explained referencing this system. Prescribed directions within the horizontal plane are the X axial directions, directions orthogonal to the X axial directions in the horizontal plane are the Y axial directions, and directions orthogonal to the X axial directions and the Y axial directions (i.e., the vertical directions) are the Z axial directions. In addition, the rotational directions (i.e., the tilting directions) around the X, Y, and Z axes are the θX, θY, and θZ directions, respectively.

### First Embodiment

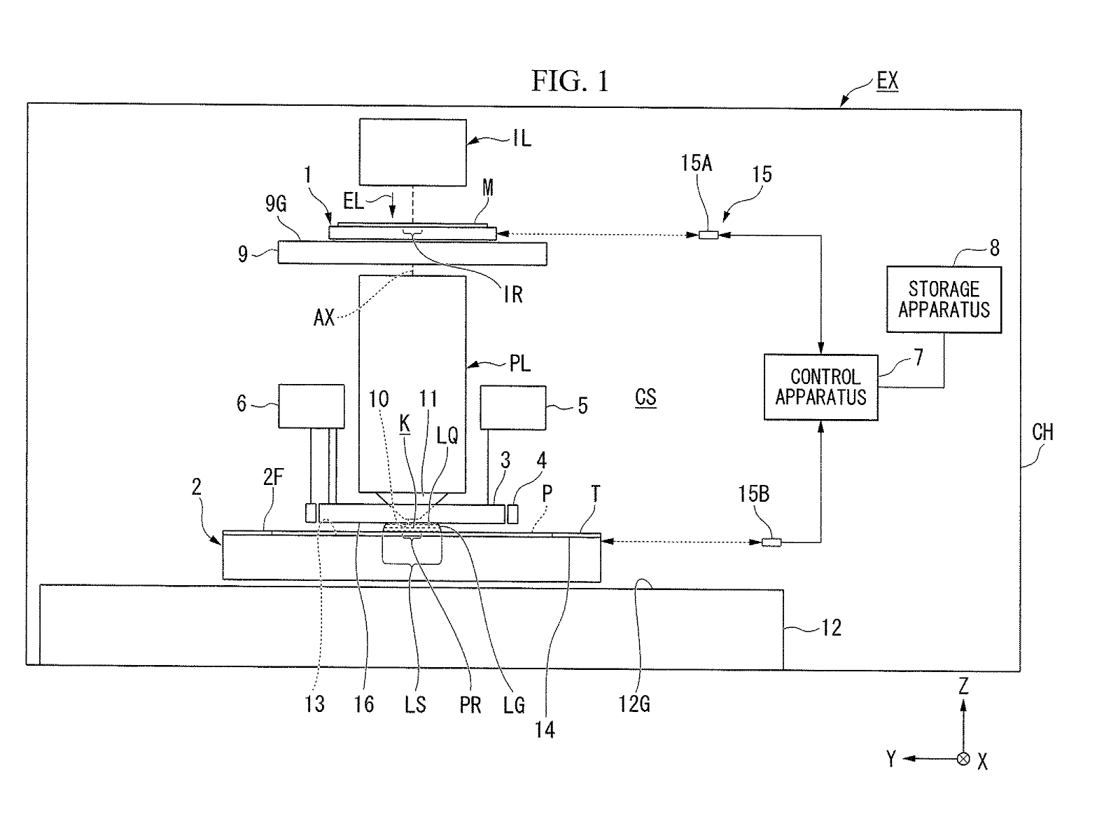

A first embodiment will now be explained. FIG. 1 is a schematic block diagram that shows one example of an exposure apparatus EX according to the first embodiment. The exposure apparatus EX of the present embodiment is an immersion exposure apparatus that exposes a substrate P with exposure light EL that passes through a liquid LQ. In the present embodiment, an immersion space LS is formed so that at least part of an optical path K of the exposure light EL is filled with the liquid LQ. The immersion space LS is a portion (i.e., a space or an area) that is filled with the liquid LQ. The substrate P is exposed with the exposure light EL, which transits the liquid LQ in the immersion space LS. In the present embodiment, water (i.e., pure water) is used as the liquid LQ.

In FIG. 1, the exposure apparatus EX includes: a movable mask stage 1 that holds a mask M; a movable substrate stage 2 that holds the substrate P; an illumination system IL that illuminates the mask M with the exposure light EL; a projection optical system PL that projects an image of a pattern of the mask M, which is illuminated by the exposure light EL, to the substrate P; a liquid immersion member 3, which forms the immersion space LS by holding the liquid LQ between itself and the substrate P such that the optical path K of the exposure light EL radiated to the substrate P is filled with the liquid LQ; a recovery member 4, which is disposed at least partly around the immersion member 3 and is capable of recovering the liquid LQ; a liquid supply apparatus 5, which is connected to the immersion member 3; a liquid recovery apparatus 6, which is connected to the immersion member 3; a control apparatus 7, which controls the operation of the entire exposure apparatus EX; and a storage apparatus 8, which is connected to the control apparatus 7 and stores various exposure-related information. The storage apparatus 8 includes a storage medium such as memory (e.g., RAM), a hard disk, a CD-ROM, and the like. In the storage apparatus 8, an operating system (OS) that controls a computer system is installed and a program for controlling the exposure apparatus EX is stored.

In addition, the exposure apparatus EX includes a chamber apparatus CH, which forms an internal space CS wherein at least the projection optical system PL, the liquid immersion member 3, the recovery member 4, and the substrate stage 2 are disposed. The chamber apparatus CH includes an environmental control apparatus, which controls the environment (i.e., the temperature, the humidity, the pressure, and the cleanliness level) of the internal space CS.

The mask M may be a reticle on which a device pattern to be projected to the substrate P is formed. The mask M may be a transmissive mask comprising a transparent plate, such as a glass plate, and the pattern, which is formed on the transparent plate using a shielding material, such as chrome. Furthermore, a reflective mask can also be used as the mask M.

The substrate P is a substrate for fabricating devices. The substrate P includes, for example, a base material, such as a semiconductor wafer, and a photosensitive film, which is formed on the base material. The photosensitive film includes a photosensitive material (e.g., photoresist). In addition to the photosensitive film, the substrate P may comprise a separate film. For example, the substrate P may comprise an antireflection film or a protective film (i.e., a topcoat film) that protects the photosensitive film.

The illumination system IL radiates the exposure light EL to a prescribed illumination area IR. The illumination area IR includes a position whereto the exposure light EL that emerges from the illumination system IL can be radiated. The illumination system IL illuminates at least part of the mask M disposed in the illumination area IR with the exposure light EL, which has a uniform luminous flux intensity distribution. Examples of light that can be used as the exposure light EL that emerges from the illumination system IL include: deep ultraviolet (DUV) light, such as a bright line (i.e., g-line, h-line, or i-line) light emitted from, for example, a mercury lamp, and KrF excimer laser light (with a wavelength of 248 nm); and vacuum ultraviolet (VUV) light, such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

In the state wherein it holds the mask M, the mask stage 1 is capable of moving on a guide surface 9G of a base member 9 that includes the illumination area IR. The mask stage 1 moves by the operation of a drive system, which includes a planar motor as disclosed in, for example, U.S. Pat. No. 6,452,292. The planar motor includes a slider, which is disposed on the mask stage 1, and a stator, which is disposed on the base member 9. In the present embodiment, the mask stage 1 is capable of moving in six directions along the guide surface 9G, namely, the X axial, Y axial, Z axial, θX, θY, and θZ directions, by the operation of the drive system.

The projection optical system PL radiates the exposure light EL to a prescribed projection area PR. The projection area PR includes a position whereto the exposure light EL that emerges from the projection optical system PL can be radiated. The projection optical system PL projects with a prescribed projection magnification an image of the pattern of the mask M to at least part of the substrate P, which is disposed in the projection area PR. The projection optical system PL of the present embodiment is a reduction system that has a projection magnification of, for example, ¼, ⅕, or ⅛. Furthermore, the projection optical system PL may be a unity magnification system or an enlargement system. In the present embodiment, an optical axis AX of the projection optical system PL is parallel to the Z axis. In addition, the projection optical system PL may be a dioptric system that does not include catoptric elements, a catoptric system that does not include dioptric elements, or a catadioptric system that includes both catoptric and dioptric elements. In addition, the projection optical system PL may form either an inverted or an erect image.

The projection optical system PL has an emergent surface 10 wherefrom the exposure light EL emerges and travels toward an image plane of the projection optical system PL. The emergent surface 10 belongs to a last optical element 11, which is the optical element of the plurality of optical elements of the projection optical system PL that is closest to the image plane of the projection optical system PL. The projection area PR includes a position whereto the exposure light EL that emerges from the emergent surface 10 can be radiated. In the present embodiment, the emergent surface 10 faces the −Z direction and is parallel to the XY plane. Furthermore, the emergent surface 10, which faces the −Z direction, may be a convex or a concave surface. The optical axis of the last optical element 11 is parallel to the Z axis. In the present embodiment, the exposure light EL that emerges from the emergent surface 10 proceeds in the −Z direction.

In the state wherein it holds the substrate P, the substrate stage 2 is capable of moving on a guide surface 9G of a base member 9, which includes the projection area PR. The substrate stage 2 moves by the operation of a drive system, which includes a planar motor as disclosed in, for example, U.S. Pat. No. 6,452,292. The planar motor includes a slider, which is disposed on the substrate stage 2, and a stator, which is disposed on the base member 9. In the present embodiment, the substrate stage 2 is capable of moving in six directions along the guide surface 9G, namely, the X axial, Y axial, Z axial, θX, θY, and θZ directions, by the operation of the drive system. Furthermore, the drive system that moves the substrate stage 2 does not have to comprise a planar motor. For example, the drive system may comprise a linear motor.

The substrate stage 2 includes a substrate holding part 13, which releasably holds the substrate P. The substrate holding part 13 holds the substrate P such that the front surface thereof faces the +Z direction. In the present embodiment, the front surface of the substrate P held by the substrate holding part 13 and an upper surface 2F of the substrate stage 2 disposed around the substrate P are disposed within the same plane (i.e., they are flush with one another). The upper surface 2F is flat. In the present embodiment, the front surface of the substrate P, which is held by the substrate holding part 13, and the upper surface 2F of the substrate stage 2 are substantially parallel to the XY plane.

Furthermore, the upper surface 2F of the substrate stage 2 and the front surface of the substrate P held by the substrate holding part 13 do not have to be disposed within the same plane; furthermore, the front surface of the substrate P or the upper surface 2F, or both, may be nonparallel to the XY plane. In addition, the upper surface 2F does not have to be flat. For example, the upper surface 2F may include a curved surface.

In addition, in the present embodiment, the substrate stage 2 includes a cover member holding part 14, which releasably holds a cover member T, as disclosed in, for example, U.S. Patent Application Publication No. 2007/0177125 and U.S. Patent Application Publication No. 2008/0049209. In the present embodiment, the upper surface 2F of the substrate stage 2 includes an upper surface of the cover member T held by the cover member holding part 14.

Furthermore, the cover member T does not have to be releasable. In such a case, the cover member holding part 14 could be omitted. In addition, the upper surface 2F of the substrate stage 2 may include the front surface of any sensor, measuring member, or the like installed on the substrate stage 2.

In the present embodiment, an interferometer system 15, which includes laser interferometer units 15A, 15B, measures the positions of the mask stage 1 and the substrate stage 2. The laser interferometer unit 15A is capable of measuring the position of the mask stage 1 using measurement mirrors that are disposed on the mask stage 1. The laser interferometer unit 15B is capable of measuring the position of the substrate stage 2 using measurement mirrors that are disposed on the substrate stage 2. When an exposing process or a prescribed measuring process is performed on the substrate P, the control apparatus 7 controls the positions of the mask stage 1 (i.e., the mask M) and the substrate stage 2 (i.e., the substrate P) based on the measurement results of the interferometer system 15.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. In the present embodiment, the scanning directions (i.e., the synchronous movement directions) of both the substrate P and the mask M are the Y axial directions. The control apparatus 7 radiates the exposure light EL to the substrate P through the projection optical system PL and the liquid LQ in the immersion space LS above the substrate P while moving the substrate P in the Y axial directions with respect to the projection area PR of the projection optical system PL and moving the mask M, synchronized to the movement of the substrate P, in the Y axial direction with respect to the illumination area IR of the illumination system IL.

The liquid immersion member 3 forms the immersion space LS such that the optical path K of the exposure light EL radiated to the projection area PR is filled with the liquid LQ. The liquid immersion member 3 forms the immersion space LS by holding the liquid LQ between itself and an object, which is disposed at a position to which the exposure light EL emerging from the emergent surface 10 of the last optical element 11 can be radiated, such that the optical path K of the exposure light EL between the last optical element 11 and the object is filled with the liquid LQ.

In the present embodiment, the position whereto the exposure light EL emerging from the emergent surface 10 can be radiated includes the projection area PR. In addition, the position whereto the exposure light EL that emerges from the emergent surface 10 can be radiated includes the position opposes the emergent surface 10. In the present embodiment, the object that is capable of being disposed at the position at which it opposes the emergent surface 10, in other words, the object that is capable of being disposed in the projection area PR, may be either the substrate stage 2 or the substrate P, which is held by the substrate stage 2 (i.e., the substrate holding part 13), or both. In the exposure of the substrate P, the liquid immersion member 3 forms the immersion space LS by holding the liquid LQ between itself and the substrate P such that the optical path K of the exposure light EL radiated to the substrate P is filled with the liquid LQ.

In the present embodiment, the liquid immersion member 3 is disposed at least partly around the last optical element 11 and the optical path K of the exposure light EL wherethrough the liquid LQ between the last optical element 11 and the object disposed in the projection area PR passes. In the present embodiment, the liquid immersion member 3 is annular. In the present embodiment, part of the liquid immersion member 3 is disposed around the last optical element 11 and part of the liquid immersion member 3 is disposed around the optical path K of the exposure light EL between the last optical element 11 and the object. The immersion space LS is formed such that the optical path K of the exposure light EL between the last optical element 11 and the object disposed in the projection area PR is filled with the liquid LQ.

Furthermore, the liquid immersion member 3 does not have to be annular. For example, the liquid immersion member 3 may be disposed partly around the last optical element 11 and the optical path K. In addition, the liquid immersion member 3 does not have to be disposed at least partly around the last optical element 11. For example, the liquid immersion member 3 may be disposed at least partly around the optical path K between the emergent surface 10 and the object and not around the last optical element 11. In addition, the liquid immersion member 3 does not have to be disposed at least partly around the optical path K between the emergent surface 10 and the object. For example, the liquid immersion member 3 may be disposed at least partly around the last optical element 11 and not around the optical path K between the emergent surface 10 and the object.

The liquid immersion member 3 has a lower surface 16 that is capable of opposing the front surface (i.e., the upper surface) of the object disposed in the projection area PR. The lower surface 16 of the liquid immersion member 3 can hold the liquid LQ between itself and the front surface of the object. In the present embodiment, some of the liquid LQ in the immersion space LS is held between the last optical element 11 and the object disposed such that it opposes the emergent surface 10 of the last optical element 11. In addition, some of the liquid LQ in the immersion space LS is held between the liquid immersion member 3 and the object disposed such that it opposes the lower surface 16 of the liquid immersion member 3. Holding the liquid LQ between the emergent surface 10 and the lower surface 16 on one side and the front surface (i.e., the upper surface) of the object on the other side forms the immersion space LS such that the optical path K of the exposure light EL between the last optical element 11 and the object is filled with the liquid LQ.

In the present embodiment, when the substrate P is being irradiated with the exposure light EL, the immersion space LS is formed such that part of the area of the front surface of the substrate P that includes the projection area PR is covered with the liquid LQ. At least part of an interface LG (i.e., a meniscus or edge) of the liquid LQ is formed between the lower surface 16 of the liquid immersion member 3 and the front surface of the substrate R Namely, the exposure apparatus EX of the present embodiment adopts a local liquid immersion system.

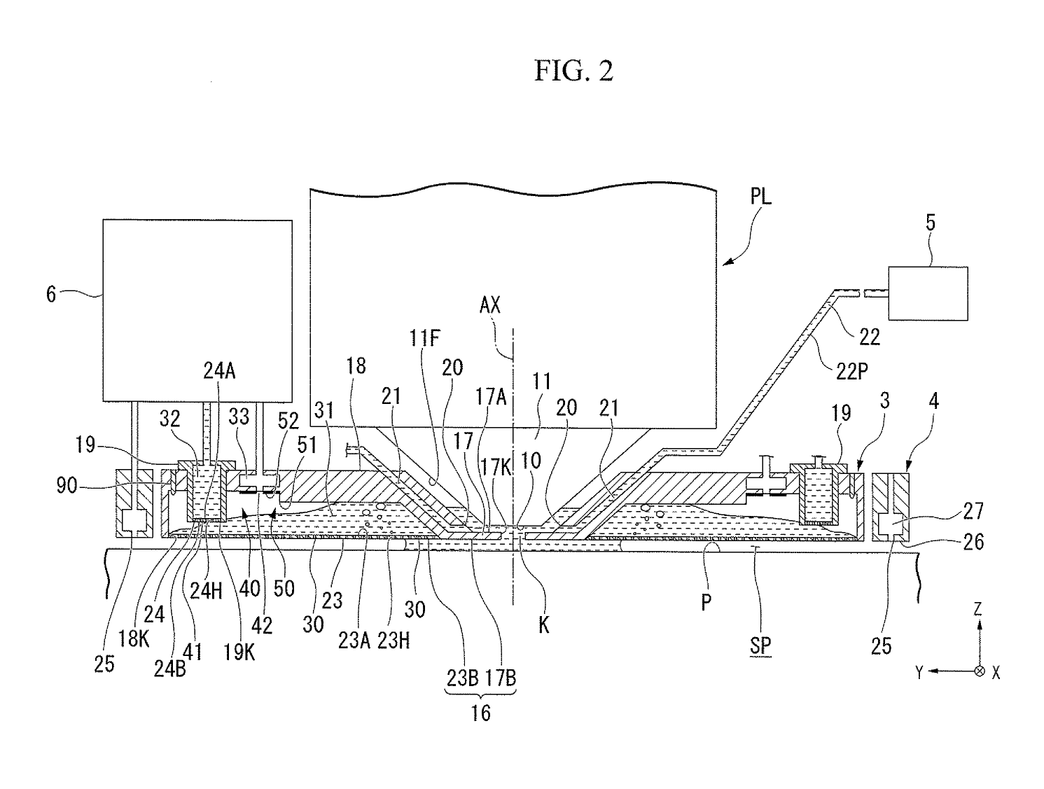

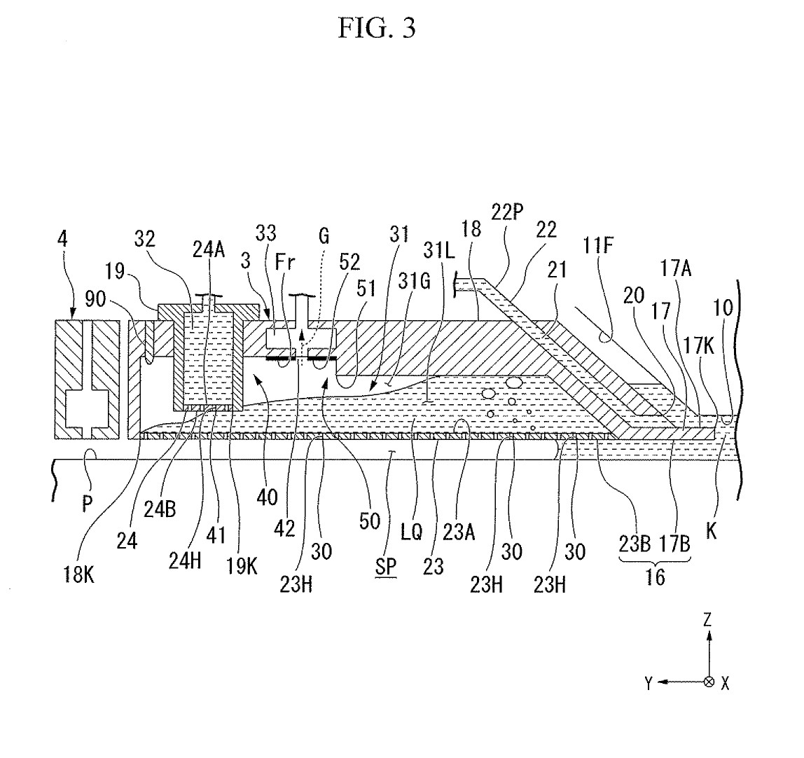

FIG. 2 is a side cross sectional view that shows one example of the liquid immersion member 3 and the recovery member 4 according to the present embodiment, and FIG. 3 shows a partial enlarged view of FIG. 2. The text below explains an exemplary case, referencing FIG. 2 and FIG. 3, wherein the substrate P is disposed in the projection area PR, but, for an example, the substrate stage 2 (i.e., the cover member T) can also be disposed in the projection area PR as discussed above.

In the present embodiment, the liquid immersion member 3 includes a plate part 17, at least part of which is disposed such that it opposes the emergent surface 10, and a main body part 18, at least part of which is disposed such that it opposes a side surface 11F of the last optical element 11. In the present embodiment, the plate part 17 and the main body part 18 are one body. The main body part 18 supports a passageway forming member 19. Furthermore, the passageway forming member 19, the plate part 17, and the main body part 18 may be one body.

Furthermore, the side surface 11F is disposed around the emergent surface 10. In the present embodiment, the side surface 11F is inclined upward toward the outer side in radial directions with respect to the optical path K. Furthermore, the radial directions with respect to the optical path K include the radial directions with respect to the optical axis AX of the projection optical system PL as well as the directions perpendicular to the Z axis.

The liquid immersion member 3 has an opening 17K, which is formed at a position at which it faces the emergent surface 10. The exposure light EL that emerges from the emergent surface 10 can be radiated through the opening 17K to the substrate P. In the present embodiment, the plate part 17 has an upper surface 17A, which opposes at least part of the emergent surface 10, and a lower surface 17B, which is capable of opposing the front surface of the substrate P. The opening 17K is a hole that is formed such that it connects the upper surface 17A and the lower surface 17B. The upper surface 17A is disposed around an upper end of the opening 17K and the lower surface 17B is disposed around a lower end of the opening 17K.

In the present embodiment, the upper surface 17A is flat. The upper surface 17A is substantially parallel to the XY plane. Furthermore, at least part of the upper surface 17A may be tilted with respect to the XY plane and may include a curved surface. In the present embodiment, the lower surface 17B is flat. The lower surface 17B is substantially parallel to the XY plane. Furthermore, at least part of the lower surface 17B may be tilted with respect to the XY plane and may include a curved surface. The lower surface 17B holds the liquid LQ between itself and the front surface of the substrate P.

The liquid immersion member 3 has: supply ports 20, which are capable of supplying the liquid LQ; recovery ports 30, which are capable of recovering the liquid LQ; a recovery passageway 31, wherethrough the liquid LQ recovered via the recovery ports 30 flows; and discharge parts 40, which separately discharge the liquid LQ and a gas G from the recovery passageway 31.

The supply ports 20 are capable of supplying the liquid LQ to the optical path K. In the present embodiment, the supply ports 20 supply the liquid LQ to the optical path K during at least part of the exposure of the substrate P. The supply ports 20 are disposed in the vicinity of the optical path K such that they face the optical path K. In the present embodiment, the supply ports 20 supply the liquid LQ to a space between the emergent surface 10 and the upper surface 17A. At least some of the liquid LQ supplied to the space between the emergent surface 10 and the upper surface 17A via the supply ports 20 is supplied to the optical path K as well as onto the substrate P via the opening 17K. Furthermore, at least part of at least one of the supply ports 20 may face the side surface 11F.

The liquid immersion member 3 includes supply passageways 21, which are connected to the supply ports 20. At least part of each of the supply passageways 21 is formed inside the liquid immersion member 3. In the present embodiment, each of the supply ports 20 includes an opening, which is formed at one end of the corresponding supply passageway 21. The other end of each of the supply passageways 21 is connected to a liquid supply apparatus 5 via a passageway 22 formed by a supply piping 22P.

The liquid supply apparatus 5 is capable of supplying the liquid LQ, which is clean and temperature adjusted. The liquid LQ that is supplied from the liquid supply apparatus 5 is supplied to the supply ports 20 via the passageway 22 and the supply passageways 21. The supply ports 20 supply the liquid LQ from the supply passageways 21 to the optical path K.

The recovery ports 30 are capable of recovering at least some of the liquid LQ from the space above the substrate P (i.e., the object). The recovery ports 30 recover at least some of the liquid LQ from the space above the substrate P during the exposure of the substrate P.

The recovery ports 30 face the Z direction. The front surface of the substrate P faces the recovery ports 30 during at least part of the exposure of the substrate P.

In the present embodiment, the liquid immersion member 3 includes a first member 23, which has the recovery ports 30.

The first member 23 has: a first surface 23B; a second surface 23A, which faces a direction other than that faced by the first surface 23B; and a plurality of holes 23H, which connect the first surface 23B and the second surface 23A. In the present embodiment, the recovery ports 30 include the holes 23H of the first member 23. In the present embodiment, the first member 23 is a porous member that has the plurality of holes 23H (i.e., openings or pores). The recovery ports 30 include the holes 23H of the porous member. Furthermore, the first member 23 may be a mesh filter, which is a porous member wherein numerous small holes are formed as a mesh. Namely, a variety of members that have holes capable of recovering the liquid LQ can serve as the first member 23.

At least part of the recovery passageway 31 is formed inside the liquid immersion member 3. In the present embodiment, an opening 18K is formed in a lower end of the recovery passageway 31. The opening 18K is disposed at least partly around the lower surface 17B. The opening 18K is formed at the lower end of the main body part 18. The opening 18K faces downward (i.e., the −Z direction). In the present embodiment, the first member 23 is disposed in the opening 18K. The recovery passageway 31 includes a space between the main body part 18 and the first member 23.

The first member 23 is disposed at least partly around the optical path K (i.e., the lower surface 17B). In the present embodiment, the first member 23 is disposed around the optical path K. Furthermore, the annular first member 23 may be disposed around the optical path K (i.e., the lower surface 17B) or a plurality of the first members 23 may be disposed such that the first members 23 are distributed around the optical path K (i.e., the lower surface 17B).

In the present embodiment, the first member 23 is a plate shaped member. The first surface 23B is one surface of the first member 23 and the second surface 23A is the other surface of the first member 23. In the present embodiment, the first surface 23B faces the space SP, which is on the lower side (i.e., the −Z side) of the liquid immersion member 3. The space SP includes, for example, the space between the lower surface 16 of the liquid immersion member 3 and the front surface of the object (i.e., the substrate P and the like) that opposes the lower surface 16 of the liquid immersion member 3. If the immersion space LS is formed above the object (i.e., the substrate P and the like) opposing the lower surface 16 of the liquid immersion member 3, then the space SP includes the immersion space LS (i.e., a liquid space) and a gas space on the outer side of the immersion space LS. In the present embodiment, the first member 23 is disposed in the opening 18K such that the first surface 23B faces the space SP and the second surface 23A faces the recovery passageway 31. In the present embodiment, the first surface 23B and the second surface 23A are substantially parallel. The first member 23 is disposed in the opening 18K such that the second surface 23A faces the +Z direction and the first surface 23B faces the opposite direction (i.e., the −Z direction) to that faced by the first [Translator's note: first should probably be second] surface 23A. In addition, in the present embodiment, the first member 23 is disposed in the opening 18K such that the first surface 23B and the second surface 23A are substantially parallel to the XY plane.

In the explanation below, the first surface 2313 is called the lower surface 23B where appropriate, and the second surface 23A is called the upper surface 23A where appropriate.

Furthermore, the first member 23 does not have to be plate shaped. In addition, the lower surface 23B and the upper surface 23A may be nonparallel. In addition, at least part of the lower surface 23B may be tilted with respect to the XY plane and may include a curved surface. In addition, at least part of the upper surface 23A may be tilted with respect to the XY plane and may include a curved surface.

The holes 23H are formed such that they connect the lower surface 23B and the upper surface 23A. The fluid (i.e., the fluid containing the gas G or the liquid LQ, or both) is capable of passing through the holes 23H of the first member 23. In the present embodiment, the recovery ports 30 include the openings at the lower ends of the holes 23H on the lower surface 23B side. The lower surface 2313 is disposed around the lower ends of the holes 23H, and the upper surface 23A is disposed around the upper ends of the holes 23H.

The recovery passageway 31 is connected to the holes 23H (i.e., the recovery ports 30) of the first member 23. The first member 23 recovers at least some of the liquid LQ from the space above the substrate P (i.e., the object) opposing the lower surface 23B via the holes 23H (i.e., the recovery ports 30). The liquid LQ recovered via the holes 23H of the first member 23 flows through the recovery passageway 31.

In the present embodiment, the lower surface 16 of the liquid immersion member 3 includes the lower surface 17B and the lower surface 23B. In the present embodiment, the lower surface 23B is disposed at least partly around the lower surface 17B. In the present embodiment, the lower surface 23B is disposed around the annular lower surface 17B. Furthermore, a plurality of the lower surfaces 23B may be disposed such that the lower surfaces 23B are distributed around the lower surface 17B (i.e., the optical path K).

The discharge parts 40 separately discharge the liquid LQ and the gas G from the recovery passageway 31. Each of the discharge parts 40 has first discharge ports 41, which face the recovery passageway 31 and are for discharging the liquid LQ from the recovery passageway 31, and a second discharge port 42, which faces the recovery passageway 31 and is for discharging the gas G from the recovery passageway 31.

In the present embodiment, the first discharge ports 41 are disposed above (i.e., in the +Z direction of) the recovery ports 30 such that they face the recovery passageway 31. The second discharge ports 42 are disposed above (i.e., in the +Z direction of) the recovery ports 30 such that they face the recovery passageway 31.

In the present embodiment, the first discharge ports 41 or the second discharge ports 42, or both, face downward (i.e., in the −Z direction). In the present embodiment, the first discharge ports 41 and the second discharge ports 42 each face downward.

In the present embodiment, the first discharge ports 41 are disposed on the outer side of the second discharge ports 42 in radial directions with respect to the optical path K. Namely, in the present embodiment, the first discharge ports 41 are farther from the optical path K than the second discharge ports 42 are.

In the present embodiment, the first member 23 recovers the liquid LQ together with the gas G from the space SP to the recovery passageway 31. The liquid LQ and the gas G in the space SP between the substrate P and the first member 23 flow to the recovery passageway 31 via the first member 23. As shown in FIG. 2 and FIG. 3, a gas space 31G and a liquid space 31L are formed in the recovery passageway 31. The first discharge ports 41 discharge the liquid LQ from the recovery passageway 31, and the second discharge ports 42 discharge the gas G from the recovery passageway 31.

In the present embodiment, the first discharge ports 41 hinder the inflow of the gas G more than the second discharge ports 42 do. The second discharge ports 42 hinder the inflow of the liquid LQ more than the first discharge ports 41 do.

In the present embodiment, the percentage of the liquid LQ in the fluid discharged via the first discharge ports 41 is greater than the percentage of the liquid LQ in the fluid discharged via the second discharge ports 42. In the present embodiment, the percentage of the gas G in the fluid discharged via the first discharge ports 41 is less than the percentage of the gas G in the fluid discharged via the second discharge ports 42.

The liquid immersion member 3 has passageways 32, which are connected to the first discharge ports 41, and passageway 33, which is connected to the second discharge ports 42. The liquid LQ discharged via the first discharge ports 41 flows through the passageways 32. The gas G discharged via the second discharge ports 42 flows through the passageway 33.

In the present embodiment, the liquid immersion member 3 includes second members 24, which have the first discharge ports 41. Each of the second members 24 has: a third surface 24B, which faces the recovery passageway 31; a fourth surface 24A, which faces a direction other than that faced by the third surface 24B; and multiple holes 24H, which connect the third surface 24B and the fourth surface 24A.

In the present embodiment, the first discharge ports 41 include the holes 24H of the second members 24. In the present embodiment, each of the second members 24 is a porous member that has the multiple holes 24H. The first discharge ports 41 include the holes 24H of the porous member. Furthermore, each of the second members 24 may be a mesh filter, which is a porous member wherein numerous small holes are formed as a mesh. Namely, a variety of members that have holes capable of hindering the inflow of the gas G can serve as each of the second members 24.

In the present embodiment, openings 19K are formed at the lower end of the passageway forming member 19. The openings 19K face downward (i.e., in the −Z direction). In the present embodiment, the second members 24 are disposed in the openings 19K.

In the present embodiment, the second members 24 are plate shaped members. Each of the third surfaces 24B is one surface of the corresponding second member 24, and each of the fourth surfaces 24A is the other surface of the corresponding second member 24. In the present embodiment, the second members 24 are disposed in the openings 19K such that the third surfaces 24B face the recovery passageway 31 and the fourth surfaces 24A face the passageways 32 of the passageway forming member 19. In the present embodiment, the third surfaces 24B and the fourth surfaces 24A are substantially parallel. The second members 24 are disposed in the openings 19K such that the fourth surfaces 24A face the +Z direction and the third surfaces 24B face the opposite direction (i.e., the −Z direction) to that faced by the fourth surfaces 24A. In addition, in the present embodiment, the second members 24 are disposed in the openings 19K such that the third surfaces 24B and the fourth surfaces 24A are substantially parallel to the XY plane.

In the explanation below, the third surfaces 2413 are called the lower surfaces 24B where appropriate, and the fourth surfaces 24A are called the upper surfaces 24A where appropriate.

Furthermore, the second members 24 do not have to be plate shaped members. In addition, the lower surfaces 24B and the upper surfaces 24A may be nonparallel. In addition, at least part of each of the lower surfaces 24B may be tilted with respect to the XY plane and may include a curved surface. In addition, at least part of each of the upper surfaces 24A may be tilted with respect to the XY plane and may include a curved surface.

The holes 24H are disposed such that they connect each of the lower surfaces 24B to the corresponding upper surface 24A. The fluid (i.e., the fluid containing the liquid LQ or the gas G, or both) can flow through the holes 24H of the second members 24. In the present embodiment, each of the first discharge ports 41 is disposed at the lower ends of the holes 24H on the corresponding lower surface 24B side. In other words, the first discharge ports 41 are the openings at the lower ends of the holes 24H. Each of the lower surfaces 24B is disposed around the lower ends of the corresponding holes 24H, and each of the upper surfaces 24A is disposed around the upper ends of the corresponding holes 24H.

Each of the passageways 32 are connected to the holes 24H (i.e., the first discharge ports 41) of the corresponding second member 24. The second members 24 discharge at least some of the liquid LQ from the recovery passageway 31 via the holes 24H (i.e., the first discharge ports 41). The liquid LQ discharged via the holes 24H of the second members 24 flows through the passageways 32.

In the present embodiment, the liquid immersion member 3 includes a hindering part 50, which is disposed in the recovery passageway 31 and hinders the liquid LQ in the recovery passageway 31 from contacting the second discharge ports 42. The hindering part 50 is provided in the recovery passageway 31 such that the second discharge ports 42 are disposed in the gas space 31G of the recovery passageway 31. The hindering part 50 adjusts the interface (surface) of the liquid space 31L in the recovery passageway 31 such that the second discharge ports 42 are disposed in the gas space 31G in the recovery passageway 31. Thereby, the second discharge ports 42 disposed in the gas space 31G can discharge substantially only the gas G from the recovery passageway 31.

In the present embodiment, the hindering part 50 includes a projection 51, which is disposed at least partly around the second discharge ports 42. The projection 51 is provided inside the recovery passageway 31 such that the second discharge ports 42 are disposed in the gas space 31G in the recovery passageway 31. The projection 51 projects downward at least partly around the second discharge ports 42. In the present embodiment, the projection 51 is formed by at least part of the inner surface of the recovery passageway 31. The projection 51 adjusts the interface of the liquid space 31L in the recovery passageway 31 such that the second discharge ports 42 are disposed in the gas space 31G in the recovery passageway 31. The projection 51 limits the movement of the interface of the liquid space 31L in the recovery passageway 31 and hinders that interface from approaching the second discharge ports 42.

In addition, in the present embodiment, the hindering part 50 includes a liquid repellent part 52, which is disposed inside the recovery passageway 31 at least partly around the second discharge ports 42 and whose surface is liquid repellent with respect to the liquid LQ.

The liquid repellent part 52 is provided inside the recovery passageway 31 such that the second discharge ports 42 are disposed in the gas space 31G in the recovery passageway 31. The liquid repellent part 52 is disposed around the second discharge ports 42. The liquid repellent part 52 adjusts the interface of the liquid space 31L in the recovery passageway 31 such that the second discharge ports 42 are disposed in the gas space 31G in the recovery passageway 31. The liquid repellent part 52 hinders the interface of the liquid space 31L in the recovery passageway 31 from approaching the second discharge ports 42 such that the peripheral space of each of the second discharge ports 42 inside the recovery passageway 31 is the gas space 31G.

In the present embodiment, the second discharge ports 42 are disposed on the outer side of the projection 51 in radial directions with respect to the optical path K. Namely, the second discharge ports 42 are farther from the optical path K than the projection 51 is. In addition, at least part of the liquid repellent part 52 is disposed between the second discharge ports 42 and the projection 51.

In the present embodiment, the liquid repellent part 52 is formed with films Fr that are liquid repellent with respect to the liquid LQ. The material used to form the films Fr is fluorine based. In the present embodiment, the films Fr are tetrafluoroethylene-perfluoro (alkyl vinyl ether) copolymer (PFA) films. Furthermore, the films Fr may also be, for example, polytetrafluoroethylene (PTFE) films, polyetheretherketone (PEEK) films, or Teflon® films. In addition, the films Fr may also be Cytop™ (made by Asahi Glass Co.) or Novec EGC™ (made by 3M Company) films.

Furthermore, the hindering part 50 does not have to the liquid repellent part 52.

In the present embodiment, the first discharge ports 41 and the second discharge ports 42 are disposed at least partly around the optical path K. In the present embodiment, the second members 24, which each have the first discharge ports 41, are disposed at prescribed intervals around the optical path K. The second discharge ports 42 are disposed at prescribed intervals around the optical path K.

The recovery member 4 is disposed at least partly around the liquid immersion member 3. In the present embodiment, the recovery member 4 is annular. The recovery member 4 is disposed such that it surrounds the liquid immersion member 3. Furthermore, a plurality of the recovery members 4 may be disposed around the liquid immersion member 3.

The recovery member 4 has a recovery port 25, which is capable of recovering at least some of the liquid LQ from the space above the substrate P (i.e., the object). The substrate P is capable of opposing the recovery port 25. The recovery member 4 has a lower surface 26, which is disposed around the recovery port 25 and which the substrate P is capable of opposing. The recovery port 25 can recover the liquid LQ from the space between the lower surface 26 and the front surface of the substrate P (i.e., the object). In addition, the recovery member 4 has a recovery passageway 27, wherethrough the liquid LQ recovered via the recovery port 25 flows. Furthermore, the liquid LQ may be recovered together with the gas G via the recovery port 25. In such a case, the gas G of high humidity around the immersion space LS is recovered via the recovery port 25.

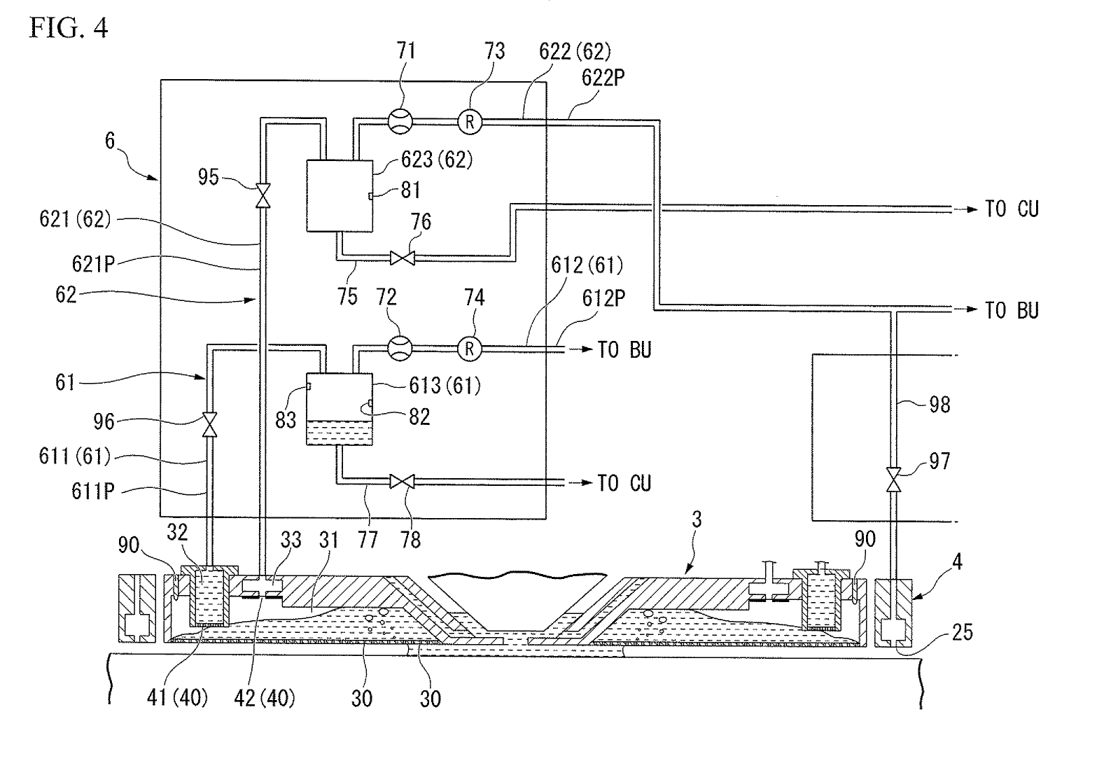

The following text explains the liquid recovery apparatus 6, referencing FIG. 4. FIG. 4 shows one example of the liquid recovery apparatus 6 according to the present embodiment.

The liquid recovery apparatus 6 includes a first passageway 61, into which the liquid LQ discharged via the first discharge ports 41 of the discharge parts 40 of the liquid immersion member 3 flows; and a second passageway 62, wherethrough the gas G discharged via the second discharge ports 42 of the discharge parts 40 flows.

The first passageway 61 is connected to the passageways 32. The first passageway 61 is connected to the first discharge ports 41 via the passageways 32. The liquid LQ discharged to the passageways 32 via the first discharge ports 41 flows into and through the first passageway 61. The second passageway 62 is connected to the passageway 33. The second passageway 62 is connected to the second discharge ports 42 via the passageway 33. The gas G discharged to the passageway 33 via the second discharge ports 42 flows into and through the second passageway 62.

In the present embodiment, the first discharge ports 41 discharge substantially only the liquid LQ from the recovery passageway 31. Substantially only the liquid LQ flows into the first passageway 61 from the recovery passageway 31 via the first discharge ports 41. In addition, in the present embodiment, the second discharge ports 42 discharge substantially only the gas G from the recovery passageway 31. Substantially only the gas G flows into the second passageway 62 from the recovery passageway 31 via the second discharge ports 42.

In the present embodiment, the liquid recovery apparatus 6 includes a first detection apparatus 71 (i.e., a flow volume sensor), at least part of which is disposed in at least part of the second passageway 62 and detects the amount of the gas G discharged via the second discharge ports 42.

In the present embodiment, the second passageway 62 includes a tank 623, a first portion 621 between the second discharge ports 42 and the tank 623, and a second portion 622 between the tank 623 and a vacuum source BU. In the present embodiment, a first discharge pipe 621P forms at least part of the first portion 621. A second discharge pipe 622P forms at least part of the second portion 622. In the present embodiment, the first detection apparatus 71 is disposed in the second portion 622.

In addition, the liquid recovery apparatus 6 includes a flow volume adjustment apparatus 73, which is capable of changing the amount of the gas G discharged via the second discharge ports 42 based on a detection result of the first detection apparatus 71. The flow volume adjustment apparatus 73 may be, for example, a pressure regulator. The flow volume adjustment apparatus 73 is capable of changing, for example, the amount of the gas G discharged via the second discharge ports 42. Furthermore, the flow volume adjustment apparatus 73 may be a mass flow controller. If the mass flow controller can detect the amount of the gas G flowing from the tank 623, then the first detection apparatus 71 may be omitted.

At least part of the flow volume adjustment apparatus 73 is disposed in at least part of the second passageway 62. In the present embodiment, the flow volume adjustment apparatus 73 is disposed in the second portion 622 of the second passageway 62.

One end of the first portion 621 is connected to the second discharge ports 42 (i.e., the passageway 33). The other end of the first portion 621 is connected to an internal space of the tank 623. One end of the second portion 622 is connected to the internal space of the tank 623. The other end of the second portion 622 is connected to the vacuum source BU. The first portion 621 and the second portion 622 are connected to a gas space inside the tank 623. In the present embodiment, the first portion 621 and the second portion 622 are connected to an upper part of the internal space of the tank 623.

Furthermore, in the present embodiment, the flow volume adjustment apparatus 73 is disposed between the first detection apparatus 71 and the vacuum source BU, but a separate tank may be further disposed or the tank 623 may be connected directly to the vacuum source BU. The first detection apparatus 71 may be disposed in the first portion 621, or both the first detection apparatus 71 and the flow volume adjustment apparatus 73 may be disposed in the first portion 621. In addition, the tank 623 may be omitted.

As discussed above, in the present embodiment, the second discharge ports 42 hinder the inflow of the liquid LQ more than the first discharge ports 41 do, and when substantially only the gas G flows into the second passageway 62 from the recovery passageway 31 via the second discharge ports 42, the internal space of the tank 623 is substantially the gas space.

Furthermore, the liquid LQ may be discharged together with the gas G via the second discharge ports 42. Namely, the liquid LQ may flow together with the gas G into the second passageway 62 via the second discharge ports 42. Furthermore, the liquid LQ may flow together with the gas G into the tank 623 via the second passageway 62. Furthermore, the internal space of the tank 623 may include the gas space and a liquid space. FIG. 4 shows the case wherein the internal space of the tank 623 is the gas space.

The tank 623 can separate the gas G and the liquid LQ discharged via the second discharge ports 42. If the gas G and the liquid LQ flow into the tank 623, then the liquid space and the gas space are formed in the internal space of the tank 623. The gas space is formed in the upper part of the internal space of the tank 623. The first portion 621 and the second portion 622 are connected to the upper part of the internal space of the tank 623. In cases wherein both the liquid space and the gas space are formed inside the tank 623, the first portion 621 and the second portion 622 are connected to the gas space formed in the upper part inside the tank 623.

In addition, the liquid recovery apparatus 6 includes a discharge passageway 75, which is connected to a lower part of the tank 623 and is capable of discharging the liquid LQ from the tank 623, and a valve mechanism 76, which is capable of opening and closing at least part of the discharge passageway 75. The valve mechanism 76 includes a variable stop and is capable not only of opening and closing the discharge passageway 75 but also of adjusting the flow volume of the liquid LQ that flows through the discharge passageway 75. In the present embodiment, the valve mechanism 76 is controlled by the control apparatus 7.

In the present embodiment, the liquid recovery apparatus 6 includes a liquid sensor 81, which is capable of detecting the amount of the liquid LQ inside the tank 623. The liquid sensor 81 is disposed in the tank 623. The liquid sensor 81 is capable of detecting the position (i.e., the liquid level, the water level) of the surface (i.e., the interface) of the liquid space inside the tank 623. The liquid sensor 81 detects the position of the surface of the liquid space inside the tank 623 and thereby detects the amount of the liquid LQ inside the tank 623. The detection result of the liquid sensor 81 will be sent to the control apparatus 7 as an output. By detecting the position (i.e., the liquid level, the water level) of the surface (i.e., the interface) of the liquid space inside the tank 623, the liquid sensor 81 can measure the amount of the liquid LQ per unit of time flowing in via the second discharge ports 42. If the amount of the liquid LQ inside the tank 623 is less than or equal to a permissible value, then the valve mechanism 76 closes the discharge passageway. If, based on the detection result of the liquid sensor 81, it is determined that the position of the surface of the liquid space inside the tank 623 (i.e., the amount of the liquid LQ inside the tank 623) exceeds the permissible value, then the control apparatus 7 controls the valve mechanism 76 to open the discharge passageway 75. Thereby, at least some of the liquid LQ inside the tank 623 is discharged via the discharge passageway 75 to, for example, a discharge part CU outside of the exposure apparatus EX (i.e., outside of the liquid recovery apparatus 6).

Furthermore, when the liquid LQ is being discharged from the tank 623, the amount of the gas G that flows into the tank 623 via the first portion 621 of the second passageway 62 is kept from changing. For example, the gas G is kept from being discharged from the tank 623 via the discharge passageway 75. For example, the liquid LQ is discharged from the tank 623 via the discharge passageway 75 such that the liquid LQ inside the tank 623 does not run out. For example, the amount of the gas G discharged from the tank 623 via the second portion 622 of the second passageway 62 may be adjusted based on the amount of the gas G discharged from the tank 623 via the discharge passageway 75. In this case, a flow rate sensor that detects the amount of the gas G discharged from the tank 623 via the discharge passageway 75 may be disposed in the discharge passageway 75.

Furthermore, the liquid sensor 81 does not have to be able to detect the amount of the liquid LQ inside the tank 623. For example, it may simply be able to detect the fact that the liquid LQ has flowed into the tank 623. In addition, the liquid sensor 81 of the liquid LQ does not have to be provided. For example, the discharge passageway 75 may be opened and closed at prescribed intervals, or may be left open.

In addition, a flow rate sensor that detects the amount of the liquid LQ discharged from the tank 623 may be disposed in the discharge passageway 75.

In addition, in the present embodiment, the liquid recovery apparatus 6 includes a pressure adjusting apparatus 74, which adjusts the pressure inside the first passageway 61. In the present embodiment, the pressure adjusting apparatus 74 is capable of adjusting the pressure inside the first passageway 61 based on the pressure inside the recovery passageway 31.

In addition, in the present embodiment, the liquid recovery apparatus 6 includes a second detection apparatus 72 (i.e., a flow volume sensor), which is disposed at least partly in the first passageway 61 and detects the amount of the gas G discharged via the first discharge ports 41. The pressure adjusting apparatus 74 is capable of adjusting the pressure in the first passageway 61 based on the detection result of the second detection apparatus 72. Furthermore, the second detection apparatus 72 does not have to be able to detect the amount of the gas G. For example, it may simply be able to detect whether the gas G is being discharged via the first discharge ports 41.

In the present embodiment, the first passageway 61 includes a tank 613, a third portion 611 between the first discharge ports 41 and the tank 613, and a fourth portion 612 between the tank 613 and the vacuum source BU. In the present embodiment, at least part of the third portion 611 is formed by a third discharge pipe 611P. At least part of the fourth portion 612 is formed by a fourth discharge pipe 612P. In the present embodiment, the second detection apparatus 72 is disposed in the fourth portion 612.

Furthermore, in the present embodiment, the pressure adjusting apparatus 74 is disposed between the second detection apparatus 72 and the vacuum source BU, but a separate tank may be further disposed. The second detection apparatus 72 may be disposed in the third portion 611.

At least part of the pressure adjusting apparatus 74 is disposed in the first passageway 61. In the present embodiment, at least part of the pressure adjusting apparatus 74 is disposed in the fourth portion 612.

One end of the third portion 611 is connected to the first discharge ports 41 (i.e., the passageways 32). The other end of the third portion 611 is connected to the internal space of the tank 613. One end of the fourth portion 612 is connected to the internal space of the tank 613. The other end of the fourth portion 612 is connected to the vacuum source BU. The third portion 611 and the fourth portion 612 are connected to a gas space inside the tank 613. In the present embodiment, the third portion 611 and the fourth portion 612 are connected to the upper part of the internal space of the tank 613.

As discussed above, in the present embodiment, the first discharge ports 41 hinder the inflow of the gas G more than the second discharge ports 42 do, and substantially only the liquid LQ flows from the recovery passageway 31 into the first passageway 61 via the first discharge ports 41.

Furthermore, the first discharge ports 41 may discharge the liquid LQ together with the gas G Namely, the liquid LQ together with the gas G may flow into the first passageway 61 via the first discharge ports 41. In addition, the liquid LQ together with the gas G may flow into the tank 613 via the first passageway 61. FIG. 4 shows a case wherein the internal space of the tank 613 includes the gas space and a liquid space.

The tank 613 can separate the gas G and the liquid LQ discharged via the first discharge ports 41. When the gas G and the liquid LQ flow into the tank 613, the liquid space and the gas space are formed inside of the tank 613 in the internal space of the tank 613. The gas space of the tank 613 is fat wed at the upper part of the internal space of the tank 613. The third portion 611 and the fourth portion 612 are connected to the upper part of the internal space of the tank 613. In cases wherein the liquid space and the gas space are formed inside the tank 613, the third portion 611 and the fourth portion 612 are connected to the gas space formed in the upper part inside the tank 613.

In addition, the liquid recovery apparatus 6 includes a discharge passageway 77, which is connected to a lower part of the tank 613 and discharges the liquid LQ separated by the tank 613, and a valve mechanism 78, which is capable of opening and closing at least part of the discharge passageway 77. The valve mechanism 78 includes a variable stop and is capable not only of opening and closing the discharge passageway 77 but also of adjusting the flow volume of the liquid LQ that flows through the discharge passageway 77. In the present embodiment, the valve mechanism 78 is controlled by the control apparatus 7.

In the present embodiment, the liquid recovery apparatus 6 includes a liquid sensor 82, which is capable of detecting the amount of the liquid LQ inside the tank 613. The liquid sensor 82 is disposed in the tank 613. The liquid sensor 82 is capable of detecting the position (i.e., the liquid level, the water level) of the surface (i.e., the interface) of the liquid space inside the tank 613. The liquid sensor 82 detects the position of the surface of the liquid space inside the tank 613 and thereby detects the amount of the liquid LQ inside the tank 613. The detection result of the liquid sensor 82 will be sent to the control apparatus 7 as an output. If the amount of the liquid LQ inside the tank 613 is less than or equal to a permissible value, then the valve mechanism 78 closes the discharge passageway 77. If, based on the detection result of the liquid sensor 82, it is determined that the position of the surface of the liquid space inside the tank 613 (i.e., the amount of the liquid LQ inside the tank 613) exceeds the permissible value, then the control apparatus 7 controls the valve mechanism 78 to open the discharge passageway 77. Thereby, at least some of the liquid LQ inside the tank 613 is discharged via the discharge passageway 77 to, for example, the discharge part CU outside of the exposure apparatus EX (i.e., outside of the liquid recovery apparatus 6).

Furthermore, when the liquid LQ is being discharged from the tank 613, the pressure inside the gas space of the tank 613 is kept from changing. For example, the gas G is kept from being discharged from the tank 613 via the discharge passageway 77. For example, the liquid LQ is discharged from the tank 613 via the discharge passageway 77 such that the liquid LQ inside the tank 613 does not run out. For example, the amount of the gas G discharged from the tank 613 via the fourth portion 612 of the first passageway 61 may be adjusted based on the amount of the gas G discharged from the tank 613 via the discharge passageway 77. In this case, a flow rate sensor that detects the amount of the gas G discharged from the tank 613 via the discharge passageway 77 may be disposed in the discharge passageway 77.

Furthermore, the liquid sensor 82 does not have to be provided. For example, the discharge passageway 77 may be opened and closed at prescribed intervals, or may be left open.

In addition, a flow rate sensor that detects the amount of the liquid LQ discharged from the tank 613 may be provided to the discharge passageway 77.

In addition, in the present embodiment, the liquid recovery apparatus 6 includes a pressure detection apparatus 83, which detects the pressure of the gas space inside the tank 613. The pressure detection apparatus 83 is disposed inside the tank 613. The detection result of the pressure detection apparatus 83 is output to the control apparatus 7. The control apparatus 7 adjusts the pressure (i.e., the negative pressure, the vacuum pressure) inside the gas space formed in the upper part of the tank 613 by controlling the pressure adjusting apparatus 74 based on the detection result of the pressure detection apparatus 83. The pressure adjusting apparatus 74 may include, for example, a pressure regulator. The pressure adjusting apparatus 74 can adjust the pressure inside the first passageway 61 and the passageways 32 by adjusting the pressure (i.e., the negative pressure) inside the gas space formed in the upper part of the tank 613.

Furthermore, the pressure inside the gas space in the upper part of the tank 613 may be adjusted by controlling the amount of the liquid LQ inside the tank 613 based on the detection result of the liquid sensor 82. In this case, the pressure adjusting apparatus 74 may be omitted, or the adjustment of the pressure inside the gas space by the pressure adjusting apparatus 74 and the adjustment of the amount of the liquid LQ inside the tank 613 may be performed in parallel. In addition, if the pressure in the gas space in the upper part of the tank 613 is adjusted by controlling the amount of the liquid LQ inside the tank 613, then the pressure detection apparatus 83 may be omitted, or the liquid sensor 82 and the pressure detection apparatus 83 may be used in parallel.

In the present embodiment, the liquid recovery apparatus 6 includes a pressure detection apparatus 90, at least part of which is disposed in the recovery passageway 31, that detects the pressure in the recovery passageway 31.

In the present embodiment, an end part of the pressure detection apparatus 90 is disposed above the first discharge ports 41. In the present embodiment, a probe (i.e., a detection part) is disposed in an end part of the pressure detection apparatus 90. In the present embodiment, the end part of the pressure detection apparatus 90 is disposed in the gas space 31G of the recovery passageway 31. Furthermore, the end part of the pressure detection apparatus 90 may be disposed in the liquid space 31L of the recovery passageway 31. In addition, the end part of the pressure detection apparatus 90 (i.e., the detection part) may be disposed in the passageway 33 and/or the second passageway 62.

In the present embodiment, the pressure adjusting apparatus 74 can adjust the pressure in the first passageway 61 based on the detection result of the pressure detection apparatus 90. In the present embodiment, the pressure adjusting apparatus 74 adjusts the pressure in the gas space inside the tank 613 based on the detection results of the pressure detection apparatuses 83, 90. Namely, the pressure adjusting apparatus 74 adjusts the pressure in the passageways 32 (i.e., the first passageway 61) based on the detection results of the pressure detection apparatuses 83, 90. The pressure adjusting apparatus 74 adjusts the difference between the pressure in the passageways 32 and the pressure in the recovery passageway 31 based on the detection results of the pressure detection apparatuses 83, 90. Furthermore, the pressure detection apparatus 83 or the pressure detection apparatus 90, or both, may be omitted. For example, if the pressure in the recovery passageway 31 is known and any pressure fluctuations are small, then the pressure detection apparatus 90 may be omitted. In addition, if the pressure in the second passageway 62 (i.e., the tank 613 and the like) is controlled such that a prescribed amount of the gas G is detected by the second detection apparatus 72 or such that the gas G is not detected by the second detection apparatus 72, then the pressure detection apparatus 83 may be omitted.

The pressure adjusting apparatus 74 adjusts the pressure in the passageways 32 (i.e., the first passageway 61) such that the gas G is hindered from flowing into the first passageway 61 via the first discharge ports 41. Namely, the difference between the pressure in the passageways 32 and the pressure in the recovery passageway 31 is adjusted such that the gas G is hindered from flowing into the first passageway 61 via the first discharge ports 41.

In the present embodiment, the pressure adjusting apparatus 74 adjusts the pressure in the passageways 32 (i.e., the first passageway 61) such that substantially only the liquid LQ, and not the gas G, is discharged from the recovery passageway 31 via the first discharge ports 41. Namely, the difference between the pressure in the passageways 32 and the pressure in the recovery passageway 31 is adjusted such that substantially only the liquid LQ, and not the gas G; is discharged from the recovery passageway 31 via the first discharge ports 41.

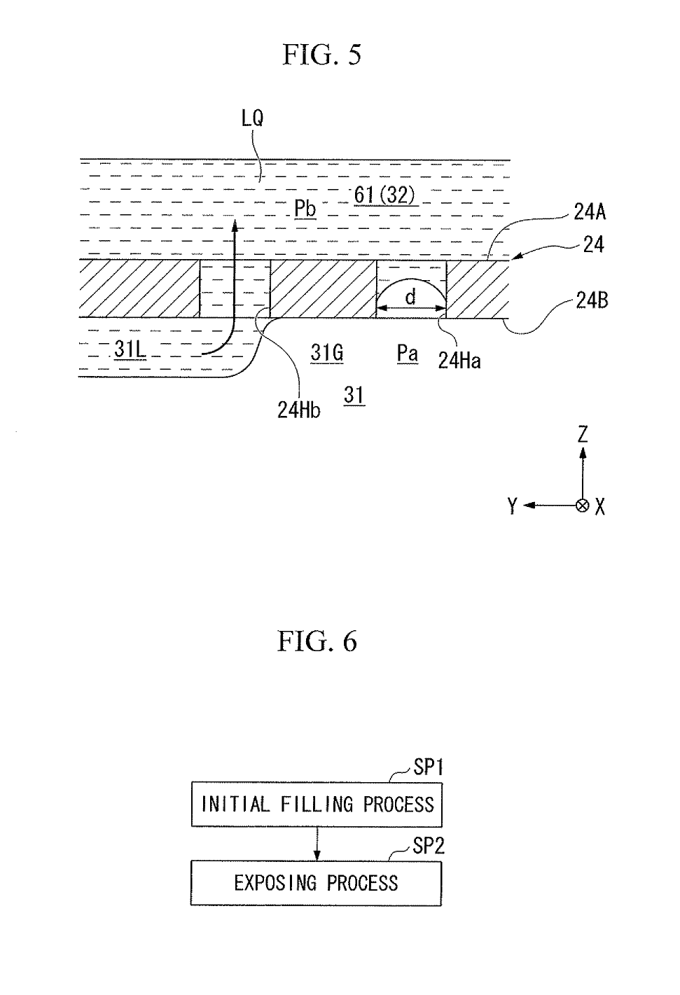

FIG. 5 is a partial, enlarged cross sectional view of one of the second members 24 and serves as a schematic drawing for explaining one example of the state wherein the second member 24 is discharging only the liquid LQ.

In FIG. 5, there is a difference between a pressure Pa in the recovery passageway 31 (i.e., the gas space 31G) and a pressure Pb in the passageway 32 (i.e., the first passageway 61). In the present embodiment, the pressure Pb in the passageway 32 is lower than the pressure Pa in the recovery passageway 31. When the liquid LQ is being recovered from the recovery passageway 31 via the second member 24, the liquid LQ is recovered from the recovery passageway 31 to the passageway 32 via a hole 24Hb of the second member 24, and the gas G is hindered from flowing into the passageway 32 via a hole 24Ha of the second member 24.

In FIG. 5, the liquid space 31L and the gas space 310 are formed in the recovery passageway 31, which faces the lower surface 24B. In FIG. 5, the space that the lower end of the hole 24Ha of the second member 24 faces is the gas space 31G, and the space that the lower end of the hole 24Hb of the second member 24 faces is the liquid space 31L. In addition, in FIG. 5, the liquid LQ (i.e., the liquid space) in the passageway 32 (i.e., the first passageway 61) is present on the upper side of the second member 24.

In the present embodiment, the liquid LQ is discharged from the recovery passageway 31 to the passageway 32 (i.e., the first passageway 61) via the hole 24Hb of the second member 24, which contacts the liquid LQ, and the flow of the gas G into the passageway 32 (i.e., the first passageway 61) via the hole 24Ha of the second member 24, which does not contact the liquid LQ, is hindered.

In FIG. 5, the condition below is satisfied.

(4×γ×cos θ)/d≦(Pb−Pa) (1)

Therein, Pa is the pressure in the gas space 31G that the lower end of the hole 24Ha faces (i.e., the pressure on the lower surface 24B side), Pb is the pressure in the passageway 32 (i.e., the first passageway 61) on the upper side of the second member 24 (i.e., the pressure on the upper surface 24A side), d is the dimension (i.e., the pore size or the diameter) of each of the holes 24Ha, 24Hb, θ is the contact angle of the liquid LQ with respect to the surface (i.e., the inner surface) of each of the holes 24H of the second member 24, and γ is the surface tension of the liquid LQ. Furthermore, to simplify the explanation, the condition expressed in the abovementioned equation (1) does not take the hydrostatic pressure of the liquid LQ on the upper side of the second member 24 into consideration.

Furthermore, in the present embodiment, the dimension d of each of the holes 24H of the second members 24 indicates the minimum value thereof of all of the holes 24H between each of the upper surfaces 24A and the corresponding lower surface 24B. Furthermore, the dimension d does not have to be the minimum dimension of all of the holes 24H between each of the upper surfaces 24A and the corresponding lower surface 24B, and may be, for example, the average value or the maximum value thereof.

In this case, the contact angle θ of the liquid LQ with respect to the surfaces of each of the holes 24H of the second members 24 satisfies the condition below.

θ≦90° (2)

If the above condition holds, then, even if the gas space 31G is formed on the lower side of the hole 24Ha of the second member 24 (i.e., in the recovery passageway 31), the gas G in the gas space 31G on the lower side of the second member 24 is hindered from moving to (i.e., flowing into) the passageway 32 (i., the liquid space) on the upper side of the second member 24 via the hole 24Ha. Namely, if the dimension d (i.e., the pore size or diameter) of the holes 2411 of the second member 24, the contact angle θ (i.e., the affinity) of the liquid LQ with respect to the surface of each of the holes 24H of the second member 24, the surface tension γ of the liquid LQ, and the pressures Pa, Pb satisfy the above condition, then the interface LG between the liquid LQ and the gas G is kept on the inner side of the hole 24Ha and the flow of the gas G from the recovery passageway 31 to the passageway 32 (i.e., the first passageway 61) via the hole 24Ha of the second member 24 is hindered. Moreover, because the liquid space 31L is formed on the lower side (i.e., on the recovery passageway 31 side) of the hole 24Hb, only the liquid LQ is discharged via the hole 24Hb.

Thus, in the present embodiment, in the state wherein the second member 24 is wetted, by virtue of the pressure differential between the liquid space (i.e., the first passageway 61) on the upper side of the second member 24 and the gas space 31G on the lower side of the second member 24 (i.e., the pressure differential between the upper surface 24A side and the lower surface 24B side) satisfying the above condition, only the liquid LQ is discharged from the holes 2411 of the second member 24.

In the explanation below, the state wherein only the liquid LQ is recovered via the holes of the porous member is called the selective recovery state where appropriate.

In addition, as shown in FIG. 4, the recovery port 25 of the recovery member 4 also can be connected to the vacuum source BU.

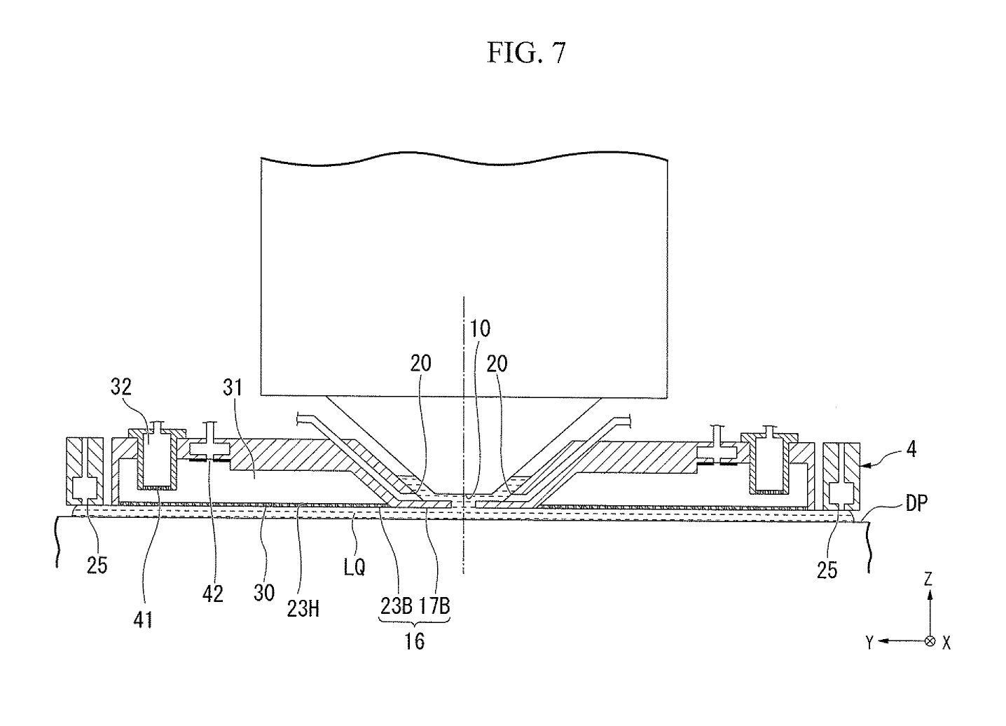

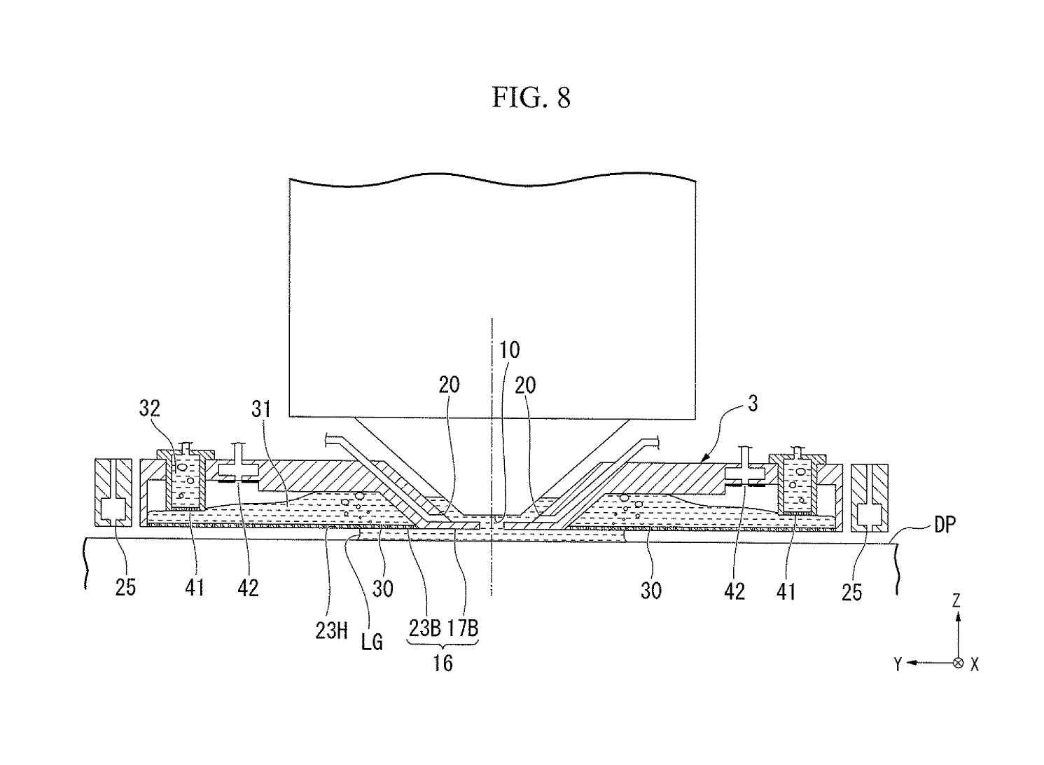

The text below explains a method of exposing the substrate P using the exposure apparatus EX that has the configuration discussed above, referencing the flow chart in FIG. 6 as well as the schematic drawings in FIG. 7 and FIG. 8. In the present embodiment, as shown in the flow chart in FIG. 6, a process that forms the immersion space LS prior to the exposure of the substrate P (i.e., a step SP1) and a process that exposes the substrate P through the liquid LQ of the immersion space LS after the immersion space LS has been formed into the desired state (i.e., a step SP2) are performed. In the explanation below, the process that forms the immersion space LS prior to the exposure of the substrate P is called the initial filling process where appropriate.

To form the immersion space LS, the control apparatus 7 disposes the object at a position at which it opposes the last optical element 11 and the liquid immersion member 3. In the present embodiment, during the initial filling process, a dummy substrate DP held by the substrate holding part 13 is disposed at a position at which it opposes the last optical element 11 and the liquid immersion member 3. The dummy substrate DP is a substrate that is not used to fabricate a device. The dummy substrate DP has substantially the same external shape as the substrate P for fabricating a device. The substrate holding part 13 is capable of holding the dummy substrate DP. Even more than the substrate P, the dummy substrate DP tends not to produce foreign matter.

Furthermore, the object disposed at a position at which it opposes the last optical element 11 and the liquid immersion member 3 during the initial filling process does not have to be the dummy substrate DP and may be the substrate P or the substrate stage 2 (i.e., the cover member T).

As shown in FIG. 7, the control apparatus 7 causes the dummy substrate DP held by the substrate stage 2 to oppose the emergent surface 10 and the lower surface 16. In the state wherein the dummy substrate DP opposes the emergent surface 10 and the lower surface 16, the control apparatus 7 starts the operation of supplying the liquid LQ via the supply ports 20.

In the present embodiment, the operation of recovering the liquid LQ via the recovery ports 30, the operation of discharging the liquid LQ via the first discharge ports 41, and the operation of discharging the gas G via the second discharge ports 42 are not performed for a prescribed time after the start of the supply of the liquid LQ via the supply ports 20. In the present embodiment, during the initial filling process, the operation of recovering the liquid LQ via the recovery port 25 of the recovery member 4 is performed in parallel with the supply of the liquid LQ via the supply ports 20. Thereby, as shown in FIG. 7, the immersion space LS is formed such that the liquid LQ contacts substantially all of the lower surface 16 of the liquid immersion member 3. Namely, the immersion space LS is formed such that substantially all of the holes 23H of the first member 23 face the liquid LQ above the dummy substrate DP.

After the prescribed time has elapsed since the start of the operation of supplying the liquid LQ via the supply ports 20 and the operation of recovering the liquid LQ via the recovery port 25, the control apparatus 7 starts the operation of discharging the fluid that includes the liquid LQ via the first discharge ports 41 and the operation of discharging the fluid that includes the gas G via the second discharge ports 42. Furthermore, simultaneous or prior to the start of the supply of the liquid LQ via the supply ports 20, the operation of discharging the fluid that includes the liquid LQ via the first discharge ports 41 and the operation of discharging the fluid that includes the gas G via the second discharge ports 42 may be started.

Furthermore, prior to the start of the discharge operation via the first discharge ports 41 or the discharge operation via the second discharge ports 42, or both, a passageway 98 may be closed by a valve mechanism 97, which is disposed in a passageway 98 that connects the recovery port 25 and the vacuum source BU.

In the present embodiment, the discharge operation via the first discharge ports 41 is started after the discharge operation via the second discharge ports 42 has started. Furthermore, the discharge operation via the first discharge ports 41 and the discharge operation via the second discharge ports 42 may be started simultaneously.

The control apparatus 7 connects the vacuum source BU and the second discharge ports 42 for the purpose of starting the discharge via the second discharge ports 42 by controlling a valve mechanism 95, which is disposed in the second passageway 62, and open the second passageway 62, and by controlling the flow volume adjustment apparatus 73. Thereby, the operation of discharging the fluid that includes the gas G from the recovery passageway 31 via the second discharge ports 42 is started. In addition, starting the discharge operation via the second discharge ports 42 lowers the pressure in the recovery passageway 31. Thereby, the operation of recovering the liquid LQ via the recovery ports 30 is started.

By performing the operation of recovering the liquid LQ via the recovery ports 30 in parallel with the operation of supplying the liquid LQ via the supply ports 20, the interface LG of the liquid LQ in the immersion space LS is formed between the lower surface 23B and the dummy substrate DP, as shown in FIG. 8.

The flow volume adjustment apparatus 73 sets the pressure Pa in the recovery passageway 31. The control apparatus 7 controls the flow volume adjustment apparatus 73 such that the pressure Pa in the recovery passageway 31 is lower than a pressure in the space SP between the last optical element 11 and the liquid immersion member 3 on one side and the dummy substrate DP on the other side. By the lowering of the pressure Pa to a pressure lower than the pressure in the space SP, at least some of the liquid LQ is recovered from the space above the dummy substrate DP to the recovery passageway 31 via the holes 23H (i.e., the recovery ports 30) of the first member 23. In addition, at least some of the gas G flows from the space SP into the recovery passageway 31 via the holes 23H.

The second discharge ports 42 discharge at least the gas G from the recovery passageway 31. Furthermore, the liquid LQ together with the gas G may be discharged via the second discharge ports 42. The fluid discharged via the second discharge ports 42 has a higher percentage of the gas G than of the liquid LQ.

The fluid including the gas G that was discharged via the second discharge ports 42 flows through the first portion 621 of the second passageway 62. In the present embodiment, because the hindering part 50, which includes the projection 51 and the liquid repellent part 52, is disposed at least partly around the second discharge ports 42, the gas G is discharged from the recovery passageway 31 via the second discharge ports 42 while the liquid LQ is hindered from flowing from the recovery passageway 31 into the second passageway 62 via the second discharge ports 42.

The first detection apparatus 71 detects the amount of the gas G discharged via the second discharge ports 42 (i.e., the amount of the gas G discharged per unit of time). The detection result of the first detection apparatus 71 will be sent to the control apparatus 7 as an output. The control apparatus 7 controls the flow volume adjustment apparatus 73 based on the detection result of the first detection apparatus 71.

The flow volume adjustment apparatus 73 is capable of changing the amount of the gas G discharged via the second discharge ports 42. The control apparatus 7 uses the flow volume adjustment apparatus 73 to adjust the amount of the gas G discharged from the recovery passageway 31 via the second discharge ports 42 based on the amount of the gas G discharged via the second discharge ports 42 detected using the first detection apparatus 71.

The amount of the gas G that flows from the space SP into the recovery passageway 31 via the recovery ports 30 varies with the amount of the gas G discharged via the second discharge ports 42. For example, if the amount of the gas G discharged via the second discharge ports 42 increases, then the amount of the gas G that flows into the recovery passageway 31 via the recovery ports 30 increases. Moreover, if the amount of the gas G discharged via the second discharge ports 42 decreases, then the amount of the gas G that flows into the recovery passageway 31 via the recovery ports 30 decreases.

Namely, the amount of the gas G that flows into the recovery passageway 31 via the recovery ports 30 is adjusted by virtue of the flow volume adjustment apparatus 73 adjusting the amount of the gas G discharged via the second discharge ports 42.

The control apparatus 7 controls the flow volume adjustment apparatus 73 based on the detection result of the first detection apparatus 71 such that the amount of the gas G discharged via the second discharge ports 42 reaches a target value. In the present embodiment, the control apparatus 7 controls the flow volume adjustment apparatus 73 based on the detection result of the first detection apparatus 71 such that the amount of the gas G that flows into the recovery passageway 31 via the recovery ports 30 reaches the target value.

Increasing the amount of the gas G that flows to the recovery passageway 31 via the recovery ports 30 hinders the contamination of the first member 23 during, for example, an exposure of the substrate P.

For example, during an exposure of the substrate P, there is a possibility that a substance (e.g., an organic substance such as the photosensitive material) produced by the substrate P will intermix with the liquid LQ in the immersion space LS, or that a substance of the substrate P will elute into the liquid LQ. That substance will act as foreign matter. In addition, along with the substance produced by the substrate P, foreign matter suspended in midair and the like might intermix with the liquid LQ of the immersion space LS. Because at least part of the first member 23 continues to contact the liquid LQ in the immersion space LS, if foreign matter intermixes with the liquid LQ, then that foreign matter might adhere to the first member 23.

If the first member 23 is left in a state wherein foreign matter is adhered, then that foreign matter might likewise adhere to the substrate P during an exposure or contaminate the liquid LQ supplied via the supply ports 20. In addition, if the lower surface 23B of the first member 23 becomes contaminated, then there is also a possibility that, for example, the immersion space LS will no longer be able to be formed satisfactorily. As a result, exposure failures might occur.

In the case wherein the liquid LQ together with the gas G is recovered via the first member 23, increasing the amount of the gas G that flows into the recovery passageway 31 via the first member 23 (i.e., the recovery ports 30) will cause the liquid LQ that is recovered together with the gas G to flow at a high velocity in the vicinity of the surface of the first member 23. Thereby, the flow of that liquid LQ can hinder the adhesion of foreign matter to the first member 23. In addition, even if foreign matter were to adhere to the surface of the first member 23, the flow of that liquid LQ could eliminate the foreign matter from the surface of the first member 23, and that eliminated foreign matter could be recovered to the recovery passageway 31 together with the liquid LQ.

Moreover, decreasing the amount of the gas G that flows to the recovery passageway 31 via the recovery ports 30 hinders, for example, the generation of vibration or the generation of a temperature change owing to the vaporization of the liquid LQ (i.e., the heat of vaporization).

The amount of the gas G that discharges via the second discharge ports 42 can be determined beforehand, for example, empirically or by simulation and the like. Furthermore, the amount of the gas G discharged via the second discharge ports 42 (i.e., the target value) may be modified. For example, the amount of the gas G discharged via the second discharge ports 42 (i.e., the target value) may be modified according to the exposure conditions to be executed. For example, a target value related to the amount of the gas G discharged via the second discharge ports 42 (i.e., the amount of the gas G that flows into the recovery passageway 31 via the recovery ports 30) may be determined beforehand in accordance with the exposure conditions, which include, for example, the amount of foreign matter that might be produced by the substrate P and the target accuracy of the pattern to be formed on the substrate P, and that target value may be stored in the storage apparatus 8. For example, if the substrate P (i.e., the photosensitive film) to be exposed is highly likely to produce foreign matter, then it is highly likely that the first member 23 will become contaminated and consequently the amount of the gas discharged via the second discharge ports 42 (i.e., the amount of the gas G that flows into the recovery passageway 31 via the recovery ports 30) will be increased; for example, if the target accuracy of the pattern to be formed on the substrate P is high, then the amount of the gas G discharged via the second discharge ports 42 (i.e., the amount of the gas G that flows into the recovery passageway 31 via the recovery ports 30) may be decreased in order to hinder the generation of vibration, heat of vaporization, and the like.

After the discharge operation via the second discharge ports 42 has been started, the control apparatus 7 connects the vacuum source BU and the first discharge ports 41 for the purpose of starting the discharge via the first discharge ports 41 by controlling a valve mechanism 96, which is disposed in the first passageway 61, and open the first passageway 61, and by controlling the pressure adjusting apparatus 74. Thereby, the operation of discharging the fluid that includes the liquid LQ from the recovery passageway 31 via the first discharge ports 41 is started.

The first discharge ports 41 discharge at least the liquid LQ from the recovery passageway 31. The gas G together with the liquid LQ may be discharged via the first discharge ports 41. The fluid discharged via the first discharge ports 41 has a higher percentage of the liquid LQ than of the gas G.

In the present embodiment, immediately after the start of the discharge operation via the first discharge ports 41, the difference between the pressure Pb in the first passageway 61 (i.e., the passageways 32) and the pressure Pa in the recovery passageway 31 is adjusted based on the detection results of the pressure detection apparatuses 83, 90 such that the gas G together with the liquid LQ is discharged via the first discharge ports 41, as shown in FIG. 8. In other words, the difference between the pressure Pa and the pressure Pb is adjusted such that it is larger than in the selective recovery state.

The fluid including the liquid LQ that was discharged via the first discharge ports 41 flows through the third portion 611 of the first passageway 61.

The second detection apparatus 72 detects the amount of the gas G included in the fluid discharged via the first discharge ports 41. The detection result of the second detection apparatus 72 will be sent to the control apparatus 7 as an output. The control apparatus 7 adjusts the difference between the pressure Pa in the recovery passageway 31 and the pressure Pb in the first passageway 61 based on the detection result of the second detection apparatus 72.

The pressure Pa in the recovery passageway 31 can be adjusted by the flow volume adjustment apparatus 73, and the pressure Pb in the first passageway 61 can be adjusted by the pressure adjusting apparatus 74.

After the discharge via the first discharge ports 41 and the discharge via the second discharge ports 42 have been started, the control apparatus 7 adjusts the pressure Pb by controlling the pressure adjusting apparatus 74 based on the detection result of the second detection apparatus 72 such that the difference between the pressure Pa in the recovery passageway 31 and the pressure Pb in the first passageway 61 becomes small. Furthermore, the pressure Pa may be adjusted. In addition, when making the difference between the pressure Pa and the pressure Pb small, the detection result of the pressure detection apparatus 83 or the detection result of the pressure detection apparatus 90, or both, may be used, but does not have to be used.

The control apparatus 7 gradually reduces the difference between the pressure Pa and the pressure Pb such that the gas G is hindered from being discharged via the first discharge ports 41. If the difference between the pressure Pa and the pressure Pb is large and the selective recovery state is not active, then the gas G together with the liquid LQ is discharged via the first discharge ports 41, and consequently the gas G is detected by the second detection apparatus 72. Moreover, by gradually reducing the difference between the pressure Pa and the pressure Pb and transitioning to the selective recovery state, only the liquid LQ is discharged via the first discharge ports 41, and consequently the gas G is no longer detected by the second detection apparatus 72.

In the present embodiment, if it is determined that the selective recovery state is not active based on the detection result of the second detection apparatus 72, then the control apparatus 7 controls the pressure adjusting apparatus 74 so as to transition to the selective recovery state. Namely, the control apparatus 7, while using the second detection apparatus 72 to verify whether the gas G is being discharged via the first discharge ports 41, adjusts the pressure Pb in the first passageway 61 by controlling the pressure adjusting apparatus 74 such that substantially only the liquid LQ is discharged from the recovery passageway 31 via the first discharge ports 41. Furthermore, the pressure Pb in the first passageway 61 may be adjusted based on the amount of the gas discharged via the first discharge ports 41 as detected by the second detection apparatus 72 such that substantially only the liquid LQ is discharged from the recovery passageway 31. In the present embodiment, when the second detection apparatus 72 no longer detects any of the gas G, the control apparatus 7 determines that the initial filling process has ended. In the present embodiment, when the state wherein the second detection apparatus 72 does not detect any of the gas G has continued for a prescribed time, the control apparatus 7 determines that the initial filling process has ended. Furthermore, in the present embodiment, in the state wherein the initial filling process has ended, the entire surface of the upper surface 23A of the first member 23 is covered with the recovered liquid LQ, as shown in FIG. 2 and FIG. 3. Of course, just part of the upper surface 23A may be covered with the liquid LQ.

Furthermore, after the second detection apparatus 72 no longer detects any of the gas G (i.e., after transitioning to the selective recovery state) and after the difference between the pressure Pa and the pressure Pb has been made small, that difference may be made large. In this case, too, the difference between the pressure Pa and the pressure Pb is made large while maintaining the selective recovery state.

Furthermore, in the present embodiment, although the difference between the pressure Pa and the pressure Pb is adjusted such that substantially only the liquid LQ and not the gas G is discharged from the recovery passageway 31 via the first discharge ports 41, the gas G together with the liquid LQ may be discharged. The difference between the pressure Pa and the pressure Pb may be adjusted such that a fluid whose percentage of the liquid LQ is greater than that of the gas G is discharged from the recovery passageway 31 via the first discharge ports 41. Namely, the difference between the pressure Pa and the pressure Pb may be set such that the amount of the gas G detected by the second detection apparatus 72 is less than a prescribed amount.

In the present embodiment, the liquid LQ and the gas G are discharged separately from the recovery passageway 31 via the discharge parts 40. In the present embodiment, substantially only the liquid LQ is discharged from the recovery passageway 31 via the first discharge ports 41. In addition, substantially only the gas G is discharged from the recovery passageway 31 via the second discharge ports 42. The liquid LQ is discharged from the recovery passageway 31 via the first discharge ports 41 and flows through the first passageway 61. The gas G is discharged from the recovery passageway 31 via the second discharge ports 42 and flows through the second passageway 62.

The gas G that is discharged via the second discharge port 42 and that flows through the first portion 621 of the second passageway 62 flows toward the vacuum source BU via the tank 623 and the second portion 622. Furthermore, if the liquid LQ together with the gas G is discharged via the second discharge ports 42, then the gas G and the liquid LQ are separated by the tank 623. The gas G separated by the tank 623 flows toward the vacuum source BU, and the liquid LQ is discharged to the discharge part CU via the discharge passageway 75 with a prescribed timing.

The liquid LQ that is discharged via the first discharge ports 41 and that flows through the third portion 611 of the first passageway 61 flows toward the tank 613. Furthermore, if the gas G together with the liquid LQ is discharged via the second discharge ports 42, then the gas G and the liquid LQ are separated by the tank 613. The gas G separated in the tank 613 flows toward the vacuum source BU, and the liquid LQ is discharged to the discharge part CU via the discharge passageway 77 with a prescribed timing.

As described above, a supply condition for supplying the liquid LQ via the supply ports 20 in order to form the immersion space LS into a desired state, a discharge condition for discharging the fluid via the first discharge ports 41, and a discharge condition for discharging the fluid via the second discharge ports 42 are all set in the initial filling process.

After the initial filling process has ended, the control apparatus 7 starts the process of exposing the substrate P. The unexposed substrate P is loaded onto the substrate holding part 13, and the immersion space LS is formed between the last optical element 11 and the liquid immersion member 3 on one side and the substrate P on the other side. The immersion space LS is formed such that the optical path K of the exposure light EL between the last optical element 11 and the substrate P is filled with the liquid LQ.

In the present embodiment, the supply condition for supplying the liquid LQ via the supply ports 20 during the substrate P exposing process, the discharge condition for discharging the fluid via the first discharge ports 41 during the substrate P exposing process, and the discharge condition for discharging the fluid via the second discharge ports 42 during the substrate P exposing process are the conditions set at the point in time when the initial filling process ends. Furthermore, after the initial filling process ends, if the pressure in the recovery passageway 31 fluctuates, then the difference between the pressure Pa and the pressure Pb may be adjusted based on the detection result of the pressure detection apparatus 90 such that the liquid LQ is discharged via the first discharge ports 41 while the gas G is hindered from being discharged via the first discharge ports 41.

The control apparatus 7 starts the process of exposing the substrate P. The control apparatus 7 radiates the exposure light EL, which emerges from the mask M illuminated with the exposure light EL from the illumination system IL, to the substrate P through the projection optical system PL and the liquid LQ in the immersion space LS. Thereby, the substrate P is exposed with the exposure light EL, which emerges from the emergent surface 10 and transits the liquid LQ in the immersion space LS, and thus the image of the pattern of the mask M is projected to the substrate P.

According to the present embodiment as explained above, the desired immersion space LS can be formed. Accordingly, it is possible to prevent exposure failures from occurring and defective devices from being produced.

Furthermore, in the present embodiment, the control apparatus 7 may use the flow volume adjustment apparatus 73 or the pressure adjusting apparatus 74, or both, to adjust the difference between the pressure Pa and the pressure Pb based on the detection result of the pressure detection apparatus 90 such that the gas G is hindered from being discharged from the recovery passageway 31 via the first discharge ports 41.

Furthermore, in the embodiment discussed above, during the initial filling process, the immersion space LS is formed such that the liquid LQ contacts substantially all of the lower surface 16 of the liquid immersion member 3 while the operation of recovering the liquid LQ via the recovery port 25 of the recovery member 4 is being performed, as shown in FIG. 7; however, this step may be omitted. Namely, the recovery of the liquid LQ via the recovery ports 30 may be started together with the start of the supply of the liquid LQ via the supply ports 20. In such a case, the recovery member 4 (i.e., the recovery port 25) may be omitted.

Furthermore, in the embodiments discussed above, the first discharge ports 41 or the second discharge ports 42, or both, do not have to oppose the upper surface 23A of the first member 23. For example, the first discharge ports 41 or the second discharge ports 42, or both, may be disposed on the outer side of an outer side end part of the first member 23 in the radial directions with respect to the optical path K. Namely, the first discharge ports 41 or the second discharge ports 42, or both, may be disposed farther from the optical path K in the radial directions with respect to the optical path K than the first member 23 is.

### Second Embodiment

A second embodiment will now be explained. In the explanation below, constituent parts that are identical or equivalent to those in the embodiment discussed above are assigned identical symbols, and the explanations thereof are therefore abbreviated or omitted.

In the first embodiment discussed above, the recovery ports 30 are disposed in the first member 23.

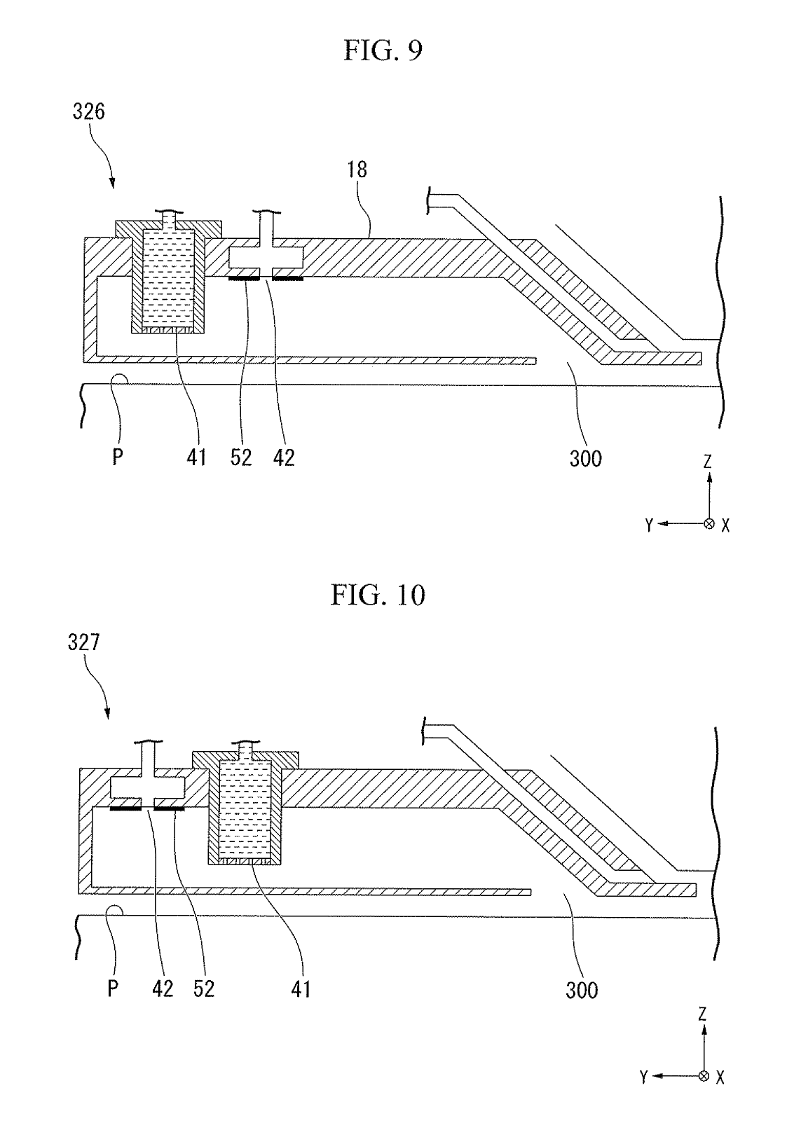

As shown in FIG. 9 through FIG. 12, the first member (23) may be omitted. Furthermore, in the embodiment of FIG. 9 through FIG. 12, the hindering part 50 does not have the projection 51.

FIG. 9 is a partial side cross sectional view of an immersion member 326 according to the second embodiment. In FIG. 9, the liquid immersion member 326 does not include the first member (i.e., the porous member). A recovery port 300 of the liquid immersion member 326 includes the opening formed at the lower end of the main body part 18.

The first discharge ports 41 and the second discharge port 42 of the liquid immersion member 326 are disposed on the outer side of the recovery port 300 in the radial directions with respect to the optical path K. The first discharge ports 41 are disposed on the outer side of the second discharge port 42 in the radial directions with respect to the optical path K.

The first discharge ports 41 and the second discharge port 42 of a liquid immersion member 327 shown in FIG. 10 is disposed on the outer side of the recovery port 300 in the radial directions with respect to the optical path K. The first discharge ports 41 are disposed on the inner side of the second discharge port 42 in the radial directions with respect to the optical path K.

The first discharge ports 41 and the second discharge port 42 of a liquid immersion member 328 shown in FIG. 11 are disposed on the inner side of the recovery port 300 in the radial directions with respect to the optical path K. The first discharge ports 41 are disposed on the outer side of the second discharge port 42 in the radial directions with respect to the optical path K.

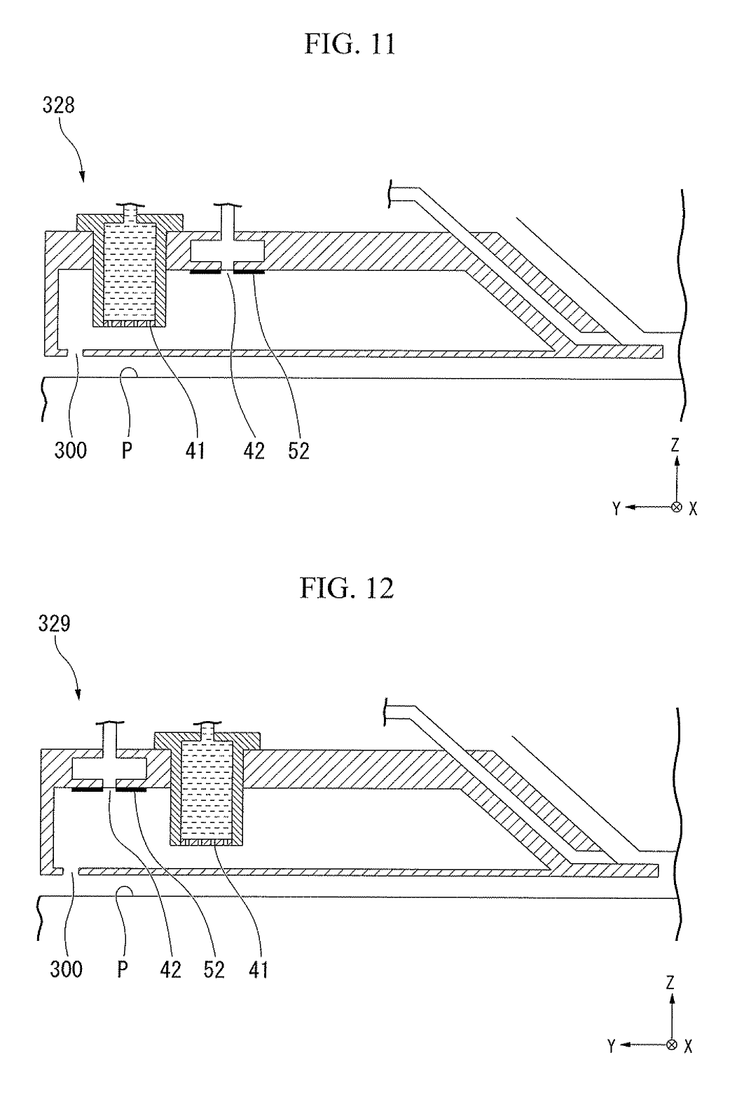

The first discharge ports 41 and the second discharge port 42 of a liquid immersion member 329 shown in FIG. 12 are disposed on the inner side of the recovery port 300 in the radial directions with respect to the optical path K. The first discharge ports 41 are disposed on the inner side of the second discharge port 42 in the radial directions with respect to the optical path K.

The liquid immersion members (326-329) of the present embodiment can be connected to the liquid recovery apparatus 6 explained in the first embodiment.

Furthermore, in each of the embodiments shown in FIG. 1 through FIG. 8, too, the first discharge ports 41 may be disposed on the inner side of the second discharge ports 42 in radial directions with respect to the optical path K, as shown in FIGS. 10 and 12. In addition, in the embodiments discussed above, the first discharge ports 41 face the −Z direction, but they may face a different direction. For example, they may face a direction parallel to the Y directions; furthermore, the third surfaces 24B of the second members 24 may be tilted with respect to the horizontal plane (i.e., the XY plane). In addition, in each of the embodiments discussed above, the second discharge ports 42 face the −Z direction, but they may face a different direction. For example, they may face the +Z direction. In addition, the direction in which the first discharge ports 41 face and the direction in which the second discharge ports 42 face may be different.

Furthermore, in each of the embodiments discussed above, the “radial directions with respect to the optical path K” may be regarded as the radial directions with respect to the optical axis AX of the projection optical system PL in the vicinity of the projection area PR.

Furthermore, as discussed above, the control apparatus 7 includes a computer system, which includes a CPU and the like.

In addition, the control apparatus 7 includes an interface, which is capable of conducting communication between the computer system and the external apparatus. The storage apparatus 8 includes a storage medium such as memory (e.g., RAM), a hard disk, a CD-ROM, and the like. In the storage apparatus 8, an operating system (OS) that controls a computer system is installed and a program for controlling the exposure apparatus EX is stored.

Furthermore, the control apparatus 7 may be connected to an input apparatus that is capable of inputting an input signal. The input apparatus includes input equipment, such as a keyboard and a mouse, or a communication apparatus, which is capable of inputting data from the external apparatus. In addition, a display apparatus, such as a liquid crystal display, may be provided.

Various information including the program stored in the storage apparatus 8 can be read by the control apparatus 7 (i.e., the computer system). In the storage apparatus 8, a program is stored that causes the control apparatus 7 to control the exposure apparatus EX such that the substrate P is exposed with the exposure light EL, which transits the liquid LQ.

The program stored in the storage apparatus 8 may cause the control apparatus 7 to execute the following processes according to the embodiments discussed above: a process that, in the state wherein the liquid immersion member is disposed at least partly around the optical path of the exposure light, forms the immersion space such that the optical path of the exposure light radiated to the substrate is filled with the liquid; a process that exposes the substrate with the exposure light, which transits the liquid in the immersion space; a process that recovers at least some of the liquid from the space above the substrate via the recovery ports of the liquid immersion member; a process that discharges the liquid from the recovery passageway of the liquid immersion member, wherethrough the liquid recovered via the recovery ports flows, via the first discharge ports which face the recovery passageway; a process that discharges the gas from the recovery passageway via the second discharge ports, which face the recovery passageway and hinder the inflow of the liquid more than the first discharge ports do; and a process that detects the amount of the gas discharged via the second discharge ports.

In addition, the program stored in the storage apparatus 8 may cause the control apparatus 7 to execute the following processes according to the embodiments discussed above: a process that, in the state wherein the liquid immersion member is disposed at least partly around the optical path of the exposure light, forms the immersion space such that the optical path of the exposure light radiated to the substrate is filled with the liquid; a process that exposes the substrate with the exposure light, which transits the liquid in the immersion space; a process that recovers at least some of the liquid from the space above the substrate via the recovery ports of the liquid immersion member; a process that discharges the liquid from the recovery passageway of the liquid immersion member, wherethrough the liquid recovered via the recovery ports flows, via the first discharge ports which face the recovery passageway; a process that discharges the gas from the recovery passageway via the second discharge ports, which face the recovery passageway and hinder the inflow of the liquid more than the first discharge ports do; and a process that detects the pressure in the recovery passageway.

In addition, the program stored in the storage apparatus 8 may cause the control apparatus 7 to execute the following processes according to the embodiments discussed above: a process that, in the state wherein the liquid immersion member is disposed at least partly around the optical path of the exposure light, forms the immersion space such that the optical path of the exposure light radiated to the substrate is filled with the liquid; a process that exposes the substrate with the exposure light, which transits the liquid in the immersion space; a process that recovers at least some of the liquid from the space above the substrate via the recovery ports of the liquid immersion member; a process that starts the discharge of a fluid including the liquid via the first discharge ports, which face the recovery passageway of the liquid immersion member into which the liquid flows via the recovery ports; a process that starts the discharge of a fluid including the gas via the second discharge ports which face the recovery passageway; a process that detects the amount of the gas discharged via the second discharge ports; and a process that adjusts the amount of the gas discharged from the recovery passageway via the second discharge ports based on the detected gas amount. In such a case, the fluid discharged via the first discharge ports has a higher percentage of the liquid than of the gas, and the fluid discharged via the second discharge ports has a higher percentage of the gas than of the liquid.

The program stored in the storage apparatus 8 is read by the control apparatus 7, and thereby the various processes, such as the immersion exposure of the substrate P in the state wherein the immersion space LS is formed, are executed in cooperation with the various apparatuses of the exposure apparatus EX, such as the substrate stage 2, the liquid immersion member 3, and the liquid recovery apparatus 6.

Furthermore, in the embodiments discussed above, the exposure apparatus EX is provided with the liquid recovery apparatus 6, but the liquid recovery apparatus 6 may be an apparatus that is external to the exposure apparatus EX. In addition, the liquid recovery apparatus 6 may be configured such that it includes the vacuum source BU, or the vacuum source BU may be an apparatus that is external to the liquid recovery apparatus 6.

Furthermore, in the embodiments discussed above, the optical path K on the emergent (i.e., the image plane) side of the last optical element 11 of the projection optical system PL is filled with the liquid LQ; however, the projection optical system PL may be a projection optical system wherein the optical path K on the incident (i.e., the object plane) side of the last optical element 11 is also filled with the liquid LQ, as disclosed in, for example, PCT International Publication No. WO2004/019128.

Furthermore, in each of the embodiments discussed above, the liquid LQ is water but may be a liquid other than water. Preferably, the liquid LQ is a liquid that is transparent with respect to the exposure light EL, has a high refractive index with respect to the exposure light EL, and is stable with respect to the projection optical system PL or the film of for example, the photosensitive material (i.e., the photoresist) that forms the front surface of the substrate P. For example, the liquid LQ may be a fluorine-based liquid such as hydro-fluoro-ether (HFE), perfluorinated polyether (PFPE), or Fomblin® oil. In addition, the liquid LQ may be any of various fluids, for example, a supercritical fluid.

Furthermore, the substrate P in each of the embodiments discussed above is a semiconductor wafer for fabricating semiconductor devices, but it may be, for example, a glass substrate for display devices, a ceramic wafer for thin film magnetic heads, or the original plate of a mask or a reticle (e.g., synthetic quartz or a silicon wafer) or the like used by an exposure apparatus.

Furthermore, the exposure apparatus EX in each of the embodiments discussed above is a step-and-scan type scanning exposure apparatus (i.e., a scanning stepper), which scans and exposes the pattern of the mask M by synchronously moving the mask M and the substrate P, but the exposure apparatus EX may be, for example, a step-and-repeat type projection exposure apparatus (i.e., a stepper), which performs a full field exposure of the pattern of the mask M—with the mask M and the substrate P in a stationary state—and then sequentially steps the substrate P.

In addition, the exposure apparatus EX may be a full-field exposure apparatus (i.e., a stitching type full-field exposure apparatus), which performs a full-field exposure of the substrate P; in this case, a step-and-repeat type exposure is performed using the projection optical system PL to transfer a reduced image of a first pattern onto the substrate P in a state wherein the first pattern and the substrate P are substantially stationary, after which the projection optical system PL is used to partially superpose a reduced image of a second pattern onto the transferred first pattern in the state wherein the second pattern and the substrate P are substantially stationary. In addition, the stitching type exposure apparatus may be a step-and-stitch type exposure apparatus that successively transfers at least two patterns onto the substrate P such that they are partially superposed and steps the substrate P.

In addition, the exposure apparatus EX may be an exposure apparatus that combines the patterns of two masks through a projection optical system on the substrate P and double exposes, substantially simultaneously, a single shot region on the substrate P using a single scanning exposure, as disclosed in, for example, U.S. Pat. No. 6,611,316. In addition, the exposure apparatus EX may be a proximity type exposure apparatus, a mirror projection aligner, or the like.

In addition, the exposure apparatus EX may be a twin stage type exposure apparatus, which includes a plurality of substrate stages, as disclosed in, for example, U.S. Pat. Nos. 6,341,007, 6,208,407, and 6,262,796. For example, if the exposure apparatus EX includes two of the substrate stages, then the object that is capable of being disposed such that it opposes the emergent surface 10 is one of the substrate stages, a substrate held by a substrate holding part on that substrate stage, the other of the substrate stages, the substrate held by a substrate holding part on that other substrate stage, or combinations thereof.

In addition, the exposure apparatus EX can also be adapted to an exposure apparatus that is provided with a substrate stage that holds a substrate and a measurement stage that does not hold the substrate to be exposed and whereon a fiducial member (wherein a fiducial mark is formed) and/or various photoelectric sensors are mounted, as disclosed in, for example, U.S. Pat. No. 6,897,963 and U.S. Patent Application Publication No. 2007/0127006. In such a case, the objects that are capable of being disposed such that they oppose the emergent surface 10 are the substrate stage, the substrate held by the substrate holding part on that substrate stage, the measurement stage, or combinations thereof. In addition, the exposure apparatus EX may be an exposure apparatus that includes a plurality of the substrate stages and the measurement stages.

The exposure apparatus EX may be a semiconductor device fabrication exposure apparatus that exposes the substrate P with the pattern of a semiconductor device, an exposure apparatus used for fabricating, for example, liquid crystal devices or displays, or an exposure apparatus for fabricating thin film magnetic heads, image capturing devices (e.g., CCDs), micromachines, MEMS, DNA chips, or reticles and masks or the like.

Furthermore, in each of the embodiments discussed above, the position of each of the stages 1 and 2 is measured using the interferometer system 15, but the present invention is not limited thereto; for example, an encoder system that detects a scale (i.e., a diffraction grating) provided to each of the stages 1 and 2 may be used, or the interferometer system 15 may be used in parallel with the encoder system.

Furthermore, in the embodiments discussed above, the optically transmissive mask M wherein a prescribed shielding pattern (or phase pattern or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, U.S. Pat. No. 6,778,257, may be used. In addition, instead of a variable shaped mask that includes a non-emissive type image display device, a pattern forming apparatus that includes a self-luminous type image display device may be provided.

In each of the embodiments discussed above, the exposure apparatus EX includes the projection optical system PL; however, the constituent elements explained in each of the embodiments discussed above may be adapted to an exposure apparatus and an exposing method that does not use the projection optical system PL. For example, the constituent elements explained in each of the embodiments discussed above may be adapted to an exposure apparatus and an exposing method wherein the immersion space LS is formed between the substrate P and an optical member such as a lens and the like, and the exposure light EL is radiated to the substrate P via that optical member.

In addition, the exposure apparatus EX may be an exposure apparatus (i.e., a lithographic system) that exposes the substrate P with a line-and-space pattern by forming interference fringes on the substrate P, as disclosed in, for example, PCT International Publication No. WO2001/035168.

The exposure apparatus EX according to the embodiments discussed above is manufactured by assembling various subsystems, including each constituent element discussed above, so that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus EX from the various subsystems includes, for example, the connection of mechanical components, the wiring and connection of electrical circuits, and the piping and connection of the pneumatic circuits and the like among the various subsystems. Prior to performing the process of assembling the exposure apparatus EX from these various subsystems, there are also the processes of assembling each individual subsystem. After the process of assembling the exposure apparatus EX from the various subsystems is complete, a comprehensive adjustment is performed to ensure the various accuracies of the exposure apparatus EX as a whole. Furthermore, it is preferable to manufacture the exposure apparatus EX in a clean room, wherein the temperature, the cleanliness level, and the like are controlled.

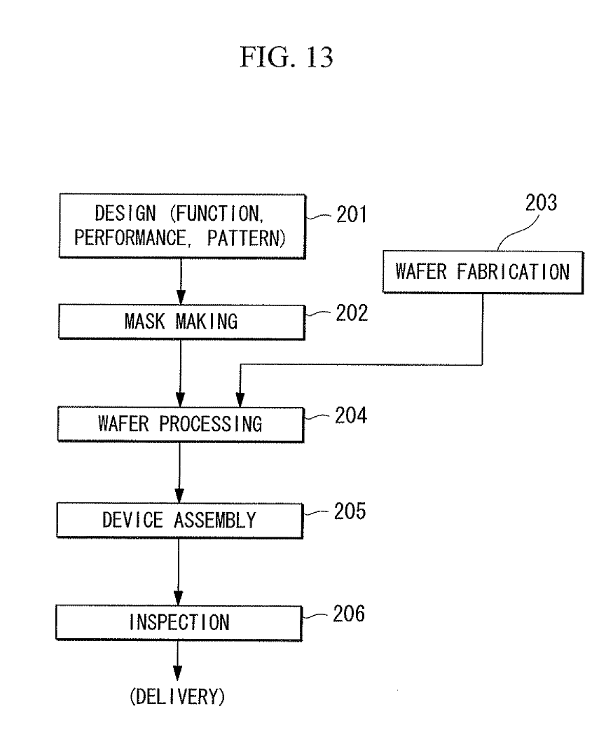

As shown in FIG. 13, a microdevice, such as a semiconductor device and the like, is manufactured by: a step 201 that designs the functions and performance of the microdevice; a step 202 that fabricates the mask M (i.e., the reticle) based on this designing step 201; a step 203 that manufactures the substrate P, which is the base material of the device; a substrate processing step 204 that includes a substrate process (i.e., an exposure process) that includes, in accordance with the embodiments discussed above, exposing the substrate P with the exposure light EL that emerges from the pattern of the mask M and developing the exposed substrate P; a device assembling step 205 (which includes fabrication processes such as dicing, bonding, and packaging processes and the like); an inspecting step 206; and the like.

Furthermore, the features of each of the embodiments discussed above can be combined as appropriate. In addition, there are also cases wherein some of the constituent elements are not used. In addition, each disclosure of every Japanese published patent application and U.S. patent related to the exposure apparatus EX recited in each of the embodiments discussed above, the modified examples, and the like is hereby incorporated by reference in its entirety to the extent permitted by the national laws and regulations.

1. A liquid recovery apparatus that is used in an immersion exposure apparatus and is connected to a liquid immersion member, which is disposed at least partly around an optical path of exposure light that passes through an optical member and a liquid between the optical member and an object, comprising:
a first passageway, which is connected to a discharge part of the liquid immersion member that separately discharges the liquid and a gas from a recovery passageway of the liquid immersion member wherethrough the liquid recovered via a recovery port of the liquid immersion member flows, into which the liquid discharged via a first discharge port of the discharge part flows;
a second passageway, into which the gas discharged via a second discharge port of the discharge part flows; and
a first detection apparatus, which is disposed in at least part of the second passageway and detects the amount of the gas discharged via the second discharge port.

2. A liquid recovery apparatus that is used in an immersion exposure apparatus and is connected to a liquid immersion member, which is disposed at least partly around an optical path of exposure light that passes through an optical member and a liquid between the optical member and an object, comprising:
a first passageway, which is connected to a first discharge port of a discharge part of the liquid immersion member that discharges the liquid and a gas from a recovery passageway of the liquid immersion member wherethrough the liquid recovered via a recovery port of the liquid immersion member flows;
a second passageway, which is connected to a second discharge port of the discharge part that hinders the inflow of the liquid more than the first discharge port does; and
a first detection apparatus, which is disposed in at least part of the second passageway and detects the amount of the gas discharged via the second discharge port.

3. The liquid recovery apparatus according to claim 1, further comprising:
a flow volume adjustment apparatus which is capable of changing the amount of the gas discharged via the second discharge port based on a detection result of the first detection apparatus.

4. The liquid recovery apparatus according to claim 3, wherein
the flow volume adjustment apparatus adjusts the amount of the gas discharged via the second discharge port and the amount of the gas that flows into the recovery passageway via the recovery port.

5. The liquid recovery apparatus according to claim 1, wherein
the second passageway comprises a tank, a first portion between the second discharge port and the tank, and a second portion between the tank and a vacuum source; and
the first detection apparatus is disposed in the second portion.

6. The liquid recovery apparatus according to claim 5, further comprising:
a flow volume adjustment apparatus, which is disposed in the second portion and is capable of changing the amount of the gas discharged via the second discharge port based on a detection result of the first detection apparatus.

7. The liquid recovery apparatus according to claim 6, wherein
the flow volume adjustment apparatus adjusts the amount of the gas discharged via the second discharge port and the amount of the gas that flows into the recovery passageway via the recovery port.

8. The liquid recovery apparatus according to claim 5, wherein
the first portion and the second portion are connected to a gas space, which is formed in an upper part of the tank.

9. The liquid recovery apparatus according to claim 5, wherein
the tank separates the gas and the liquid discharged via the second discharge port.

10. The liquid recovery apparatus according to claim 5, further comprising:
a discharge passageway, which is connected to a lower part of the tank and discharges the liquid separated by the tank.

11. The liquid recovery apparatus according to claim 1, further comprising:
a pressure adjusting apparatus, which adjusts the pressure in the first passageway.

12. The liquid recovery apparatus according to claim 11, wherein
the pressure adjusting apparatus adjusts the pressure in the first passageway based on the pressure in the recovery passageway.

13. The liquid recovery apparatus according to claim 11, wherein
the pressure adjusting apparatus adjusts the pressure in the first passageway such that the gas is hindered from flowing into the first passageway via the first discharge port.

14. The liquid recovery apparatus according to claim 11, wherein
the pressure adjusting apparatus adjusts the pressure in the first passageway such that substantially only the liquid is recovered from the recovery passageway via the first discharge port.

15. The liquid recovery apparatus according to claim 11, further comprising:
a second detection apparatus, which detects the amount of the gas discharged via the first discharge port;
wherein,
the pressure adjusting apparatus adjusts the pressure in the first passageway based on a detection result of the second detection apparatus.

16. The liquid recovery apparatus according to claim 1, wherein
the first passageway comprises a tank, a third portion between the first discharge port and the tank, and a fourth portion between the tank and a vacuum source; and
the pressure adjusting apparatus adjusts the pressure in the gas space formed in the upper part of the tank.

17. The liquid recovery apparatus according to claim 16, wherein
the third portion and the fourth portion are connected to the gas space formed in the upper part of the tank.

18. The liquid recovery apparatus according to claim 16, further comprising:
a second detection apparatus, which is disposed in the fourth portion and detects the amount of the gas discharged via the first discharge port;
wherein,
the pressure adjusting apparatus adjusts the pressure in the first passageway based on a detection result of the second detection apparatus.

19. The liquid recovery apparatus according to claim 16, wherein
at least part of the pressure adjusting apparatus is disposed in the fourth portion.

20. The liquid recovery apparatus according to claim 16, wherein
the tank separates the gas and the liquid discharged via the first discharge port.

21. The liquid recovery apparatus according to claim 16, further comprising:
a discharge passageway, which is connected to the lower part of the tank and discharges the liquid separated by the tank.

22. The liquid recovery apparatus according to claim 1, further comprising:
a pressure detection apparatus, at least part of which is disposed in the recovery passageway and detects the pressure in the recovery passageway.

23. The liquid recovery apparatus according to claim 22, wherein
an end part of the pressure detection apparatus is disposed above the first discharge port.

24. A liquid recovery apparatus that is used in an immersion exposure apparatus and is connected to a liquid immersion member, which is disposed at least partly around an optical path of exposure light that passes through an optical member and a liquid between the optical member and an object, comprising:
a first passageway, which is connected to a discharge part of the liquid immersion member that separately discharges the liquid and a gas from a recovery passageway of the liquid immersion member wherethrough the liquid recovered via a recovery port of the liquid immersion member flows, into which the liquid discharged via a first discharge port of the discharge part flows;
a second passageway, into which the gas discharged via a second discharge port of the discharge part flows; and
a pressure detection apparatus, at least part of which is disposed in the recovery passageway and detects the pressure in the recovery passageway.

25. A liquid recovery apparatus that is used in an immersion exposure apparatus and is connected to a liquid immersion member, which is disposed at least partly around an optical path of exposure light that passes through an optical member and a liquid between the optical member and an object, comprising:
a first passageway, which is connected to a first discharge port of a discharge part of the liquid immersion member that discharges the liquid and a gas from a recovery passageway of the liquid immersion member wherethrough the liquid recovered via a recovery port of the liquid immersion member flows;
a second passageway, which is connected to a second discharge port of the discharge part that hinders the inflow of the liquid more than the first discharge port does; and
a pressure detection apparatus, at least part of which is disposed in the recovery passageway and detects the pressure in the recovery passageway.

26. The liquid recovery apparatus according to claim 24, wherein
an end part of the pressure detection apparatus is disposed above the first discharge port.

27. The liquid recovery apparatus according to claim 24, further comprising:
a pressure adjusting apparatus, which adjusts the pressure in the first passageway based on a detection result of the pressure detection apparatus.

28. The liquid recovery apparatus according to claim 27, wherein
the pressure adjusting apparatus adjusts the pressure in the first passageway such that the gas is hindered from flowing into the first passageway via the first discharge port.

29. The liquid recovery apparatus according to claim 27, wherein
the pressure adjusting apparatus adjusts the pressure in the first passageway such that substantially only the liquid is recovered from the recovery passageway via the first discharge port.

30. The liquid recovery apparatus according to claim 27, further comprising:
a second detection apparatus, which detects the amount of the gas discharged via the first discharge port;
wherein,
the pressure adjusting apparatus adjusts the pressure in the first passageway based on a detection result of the second detection apparatus.

31. The liquid recovery apparatus according to claim 27, wherein
the first passageway comprises a tank, a third portion between the first discharge port and the tank, and a fourth portion between the tank and a vacuum source; and
the pressure adjusting apparatus adjusts the pressure in a gas space formed in the upper part of the tank.

32. The liquid recovery apparatus according to claim 31, wherein
the third portion and the fourth portion are connected to the gas space formed in the upper part of the tank.

33. The liquid recovery apparatus according to claim 31, further comprising:
a second detection apparatus, which is disposed in the fourth portion and detects the amount of the gas discharged via the first discharge port;
wherein,
the pressure adjusting apparatus adjusts the pressure in the first passageway based on a detection result of the second detection apparatus.

34. The liquid recovery apparatus according to claim 31, wherein
at least part of the pressure adjusting apparatus is disposed in the fourth portion.

35. The liquid recovery apparatus according to claim 31, wherein
the tank separates the gas and the liquid discharged via the second discharge port.

36. The liquid recovery apparatus according to claim 31, further comprising:
a discharge passageway, which is connected to a lower part of the tank and discharges the liquid separated by the tank.

37. The liquid recovery apparatus according to claim 1, wherein
the recovery port comprises a hole of a porous member.

38. The liquid recovery apparatus according to claim 1, wherein
the first discharge port comprises a hole of a porous member.

39. The liquid recovery apparatus according to claim 1, wherein
substantially only the gas flows from the recovery passageway into the second passageway via the second discharge port.

40. The liquid recovery apparatus according to claim 1, wherein
the first discharge port hinders the inflow of the gas more than the second discharge port does.

41. An exposure apparatus that exposes a substrate with exposure light via a liquid, comprising:
an optical member, wherefrom the exposure light emerges;
a liquid immersion member, which is disposed at least partly around an optical path of the exposure light that passes through the liquid between the optical member and an object; and
a liquid recovery apparatus according to claim 1.

42. A device fabricating method, comprising:
exposing a substrate using an exposure apparatus according to claim 41; and
developing the exposed substrate.

43. A liquid recovering method that is used in an immersion exposure apparatus and recovers a liquid via a recovery port of a liquid immersion member disposed at least partly around an optical path of exposure light, comprising:
discharging the liquid from a recovery passageway of the liquid immersion member, wherethrough the liquid recovered via the recovery port flows, via a first discharge port, which faces the recovery passageway;
discharging a gas from the recovery passageway via a second discharge port, which faces the recovery passageway and hinders the inflow of the liquid more than the first discharge port does; and
detecting the amount of the gas discharged via the second discharge port.

44. The liquid recovering method according to claim 43, comprising:
adjusting the amount of the gas discharged via the second discharge port based on a gas amount detection result.

45. The liquid recovering method according to claim 44, wherein
the amount of the gas discharged via the second discharge port is adjusted and the amount of the gas that flows into the recovery passageway via the recovery port is adjusted.

46. The liquid recovering method according to claim 43, comprising:
detecting the amount of the gas discharged via the first discharge port; and
adjusting the pressure in a first passageway, which is connected to the recovery passageway via the first discharge port, based on the gas amount detection result.

47. The liquid recovering method according to claim 43, comprising:
detecting the pressure in the recovery passageway; and
adjusting the pressure in a first passageway, which is connected to the recovery passageway via the first discharge port, based on a pressure detection result.

48. The liquid recovering method according to claim 47, comprising:
adjusting the pressure in the first passageway based on the pressure detection result such that the gas is hindered from being discharged from the recovery passageway via the first discharge port.

49. The liquid recovering method according to claim 47, wherein
the pressure in the recovery passageway is detected by a pressure detection apparatus, at least part of which is disposed in the recovery passageway of the liquid immersion member.

50. A liquid recovering method that is used in an immersion exposure apparatus and recovers a liquid via a recovery port of a liquid immersion member disposed at least partly around an optical path of exposure light, comprising:
discharging the liquid from a recovery passageway of the liquid immersion member, wherethrough the liquid recovered via the recovery port flows, via a first discharge port, which faces the recovery passageway;
discharging a gas from the recovery passageway via a second discharge port, which faces the recovery passageway and hinders the inflow of the liquid more than the first discharge port does; and
detecting the pressure in the recovery passageway.

51. The liquid recovering method according to claim 50, comprising:
adjusting a pressure in a first passageway, which is connected to the recovery passageway via the first discharge port, based on a result of detecting the pressure.

52. The liquid recovering method according to claim 51, comprising:
adjusting the pressure in the first passageway based on the result of detecting the pressure such that the gas is hindered from being discharged from the recovery passageway via the first discharge port.

53. The liquid recovering method according to claim 43, wherein
the first discharge port hinders the inflow of the gas more than the second discharge port does.

54. The liquid recovering method according to claim 43, wherein
the first discharge port includes a hole of a porous member.

55. A liquid recovering method that is used in an immersion exposure apparatus and recovers a liquid from a space above an object, which opposes a recovery port of a liquid immersion member disposed at least partly around an optical path of exposure light, via the recovery port, comprising:
starting the discharge of a fluid, which includes the liquid, via a first discharge port, which faces a recovery passageway of the liquid immersion member into which the liquid flows via the recovery port;
starting the discharge of the fluid, which includes a gas, via a second discharge port, which faces the recovery passageway;
detecting the amount of the gas discharged via the second discharge port; and
adjusting the amount of the gas discharged from the recovery passageway via the second discharge port based on the detected gas amount;
wherein,
the fluid discharged via the first discharge port has a higher percentage of the liquid than of the gas; and
the fluid discharged via the second discharge port has a higher percentage of the gas than of the liquid.

56. The liquid recovering method according to claim 55, wherein
at least one discharge selected from the group consisting of the discharge via the first discharge port and the discharge via the second discharge port is started after the supply of the liquid via a supply port of the liquid immersion member has started.

57. The liquid recovering method according to claim 55, further comprising:
after the discharge via the first discharge port has started, adjusting a pressure differential between a first passageway, into which the liquid discharged via the first discharge port flows, and the recovery passageway.

58. The liquid recovering method according to claim 57, wherein
after the discharge via the first discharge port has started, the pressure differential is made small.

59. The liquid recovering method according to claim 58, wherein
after the discharge via the second discharge port has started, the pressure differential is made small.

60. The liquid recovering method according to claim 58, further comprising:
after the pressure differential has been made small, making the pressure differential large.

61. The liquid recovering method according to claim 57, wherein
the pressure differential is adjusted such that the fluid whose percentage of the liquid is higher than its percentage of the gas is discharged from the recovery passageway via the first discharge port.

62. The liquid recovering method according to claim 57, wherein
the pressure differential is adjusted such that substantially only the liquid is discharged from the recovery passageway via the first discharge port.

63. The liquid recovering method according to claim 57, further comprising:
detecting the amount of the gas discharged from the recovery passageway via the first discharge port;
wherein,
the pressure differential is adjusted based on the detected gas amount.

64. The liquid recovering method according to claim 57, further comprising:
detecting the pressure in the recovery passageway;
wherein,
the pressure differential is adjusted based on the detected pressure.

65. The liquid recovering method according to claim 57, wherein
the adjustment of the pressure differential includes the adjustment of the pressure in the first passageway.

66. The liquid recovering method according to claim 55, wherein
the discharge via the first discharge port is started with a timing selected from the group consisting of at the same time as the discharge via the second discharge port and after the start of the discharge via the second discharge port.

67. The liquid recovering method according to claim 55, wherein
substantially only the gas is discharged from the recovery passageway via the second discharge port.

68. A device fabricating method, comprising:
recovering, using a liquid recovering method according to claim 43, at least some of a liquid that fills an optical path of exposure light radiated to a substrate;
exposing the substrate with the exposure light through the liquid; and developing the exposed substrate.

69. A program that causes a computer to control an exposure apparatus, which exposes a substrate with exposure light that transits a liquid, comprising the steps of:
in a state wherein a liquid immersion member is disposed at least partly around an optical path of the exposure light, forming an immersion space such that the optical path of the exposure light radiated to the substrate is filled with the liquid;
exposing the substrate with the exposure light, which transits the liquid in the immersion space;
recovering at least some of the liquid from a space above the substrate via a recovery port of the liquid immersion member;
discharging the liquid from a recovery passageway of the liquid immersion member, wherethrough the liquid recovered via the recovery port flows, via a first discharge port, which faces the recovery passageway;
discharging a gas from the recovery passageway via a second discharge port, which faces the recovery passageway and hinders the inflow of the liquid more than the first discharge port does; and
detecting the amount of the gas discharged via the second discharge port.

70. A program that causes a computer to control an exposure apparatus, which exposes a substrate with exposure light that transits a liquid, comprising the steps of:
in a state wherein a liquid immersion member is disposed at least partly around an optical path of the exposure light, forming an immersion space such that the optical path of the exposure light radiated to the substrate is filled with the liquid;
exposing the substrate with the exposure light, which transits the liquid in the immersion space;
recovering at least some of the liquid from a space above the substrate via a recovery port of the liquid immersion member;
discharging the liquid from a recovery passageway of the liquid immersion member, wherethrough the liquid recovered via the recovery port flows, via a first discharge port, which faces the recovery passageway;
discharging a gas from the recovery passageway via a second discharge port, which faces the recovery passageway and hinders the inflow of the liquid more than the first discharge port does; and
detecting the pressure in the recovery passageway.

71. A program that causes a computer to control an exposure apparatus, which exposes a substrate with exposure light that transits a liquid, comprising the steps of:
in the state wherein a liquid immersion member is disposed at least partly around an optical path of the exposure light, forming an immersion space such that the optical path of the exposure light radiated to the substrate is filled with the liquid;
exposing the substrate with the exposure light, which transits the liquid in the immersion space;
recovering at least some of the liquid from a space above the substrate via a recovery port of the liquid immersion member;
starting the discharge of a fluid including the liquid via a first discharge port, which faces a recovery passageway of the liquid immersion member into which the liquid flows via the recovery port;
starting the discharge of a fluid including a gas via a second discharge port, which faces the recovery passageway;
detecting the amount of the gas discharged via the second discharge port; and
adjusting the amount of the gas discharged from the recovery passageway via the second discharge port based on the detected gas amount;
wherein,
the fluid discharged via the first discharge port has a higher percentage of the liquid than of the gas; and
the fluid discharged via the second discharge port has a higher percentage of the gas than of the liquid.

72. A computer readable storage medium whereon a program according to claim 69 is stored.
